(19) United States
(12) Patent Application Publication
(10) Pub. No.: US 2005/0066264 A1
(43) Pub. Date: Mar. 24, 2005

(54) Manual preparation support method, program and storage medium

(75) Inventors: Tadashi Ohashi, Kawasaki (JP); Yukiharu Hashiguchi, Tokyo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/911,628

(22) Filed: Aug. 5, 2004

Related U.S. Application Data
(63) Continuation of application No. PCT/JP02/01137, filed on Feb. 12, 2002.

(51) Int. Cl. G06F 17/00

(52) U.S. Cl. 715/500

(57) ABSTRACT

A process simulation step supports manual artwork development planning for manual artwork development through simulation of processes from manual preparation request to delivery based on information entered by the requesting side. A preparation request step transmits a manual preparation request prepared by the requesting side to the developing side. A process management step accepts the preparation request, acquires an assigned number, and provides the progress status of processes from draft forwarding to artwork development and bookbinding in a visible manner on the developing side. An artwork development step prepares artwork by way of receipt of draft from the requesting side, and editing, proofreading and technical check on the developing and requesting sides. A bookbinding/distribution step handles manual bookbinding and/or recording to an electronified medium based on the prepared artwork.

### TECHNICAL FIELD

The present invention relates to a manual preparation support method, programs, and storage medium for preparing manuals for hardware and other products through electronic processings, and more particularly to a manual preparation support method, programs, and storage medium for proceeding with process tasks from requesting and artwork development to bookbinding and distribution using a Web environment.

### BACKGROUND ART

In the development of hardware products such as personal computers and printers, their manuals have conventionally been prepared in parallel, and, to develop an artwork for manual preparation, the designer prepares a draft by collecting development and design materials.

Normally, the responsible designer creates text for the manual's draft using a word processor or something similar and cites all circuit, configuration, schematic and construction diagrams necessary for the manual from design drawings. In the absence of appropriate materials, the designer prepares original materials for the manual.

Once the draft preparation is complete, the design department places an order to an artwork development department in charge of artwork development, thus commissioning the work. In response to a received manual preparation request, the artwork development department receives the draft from the responsible designer and prepares an artwork draft through editing. In this preparation of an artwork draft, the edited artwork draft is returned to the developer, a requesting source, several times for proofreading for artwork preparation followed by delivery.

In response to delivery of the artwork, the design department places an order to a bookbinding/printing department in charge of bookbinding/printing, thus commissioning the work. The bookbinding/printing department prints and bookbinds the manual or records the manual to an electronic medium such as CD-ROM based on the artwork for delivery.

Artwork development and bookbinding/printing in conventional development of manuals for hardware and others, however, involves the following problems.

In general, product development, an essential task of the designer, takes up almost all of his or her time, with no schedule or time left for writing the hardware manual's draft and other documents, thus leaving almost all of the draft preparation tasks in the hands of the artwork development department.

Once a product model is decided upon, and if a number of products are developed as series of that model, artwork for the manual is developed by reusing a first draft as is, making the manual contents likely to become universal and shallow.

The artwork development department, tasked with development of wide-ranging manual artworks requested from the design department, may not be able to exercise sufficient process control.

The responsible staff member of the artwork development department must visit the designer for documents related to artwork development, requiring time and effort to obtain documents, etc.

It is necessary, for the purpose of review of the artwork draft, to request the design department to conduct proofreading a number of times, making it one of the major factors of time-consuming artwork development.

It is an object of the present invention to provide a manual preparation support method, programs, and storage medium for ensuring proper execution of tasks with high efficiency on the requesting and development sides alike for hardware and other manual preparation, from artwork development to bookbinding.

### DISCLOSURE OF THE INVENTION

A manual preparation support method of the present invention comprises:

a process simulation step of supporting manual artwork development planning for manual artwork development through simulation of processes from manual preparation request to delivery based on information entered by the requesting side;

a preparation request step of transmitting a manual preparation request prepared by the requesting side to the developing side;

a process management step of accepting the preparation request, acquiring an assigned number, and providing the progress status of processes from draft forwarding to artwork development and bookbinding in a visible manner on the developing side;

an artwork development step of preparing artwork by way of receipt of draft from the requesting side, and editing, proofreading and technical check on the developing and requesting sides; and

a bookbinding/distribution step of delivering a manual by handling bookbinding and/or recording to an electronified medium.

According to the present invention, for this reason, it is possible for the requesting designer to simulate all the processes of manual preparation in advance, thus allowing optimal development planning. Besides, the draft and related documents for artwork development are provided as electronic data to the staff member responsible for artwork development by the designer, thus speeding up artwork development.

As for proofreading request for review of the artwork draft by the design department and return of the proofread draft, the request and the proofread draft are exchanged as electronic data, allowing speedy exchanges irrespective of increased number of exchanges. Besides, it is possible to transmit the edited artwork draft to the design side for technical check, thus making the checked artwork draft an electronified, completed artwork as is when it is returned and allowing immediate initiation of artwork preparation and bookbinding.

The process simulation step includes setting work items, language, number of pages of draft, scheduled submission date, desired date, and number of times of proofreading as basic information for specifying data format on web, and wherein the process simulation step includes displaying and outputting individual processes of draft submission, artwork ordering, draft request, return of proofread draft, another request for proofreading, another return of proofread draft, artwork delivery, artwork registration, artwork electronification, completion of bookbinding, and completion of CD-ROM through simulation based on the basic information.

The preparation request step includes:

a request type specification step of specifying new request, new reuse request, reuse request in other language or revision request; and

an entry step of entering given basic information, requesting source information and destinations of distribution related to preparation request.

Thus, a variety of manual models (frameworks) are available, resulting in speedy development of wide-ranging manuals.

The new request step includes entering work items, language, number of pages of draft, scheduled submission date, desired date, and number of times of proofreading as the basic information for specifying data format on web and entering whether or not approval is necessary, date of request, requester, approver, product number, document number, and destination of technical inquiry as the requesting source information.

The process management step includes rendering processes visible by separating the processes into draft submission, artwork ordering, draft request, return of proofread draft, another request for proofreading, another return of proofread draft, artwork delivery, artwork registration, artwork electronification, completion of bookbinding, and completion of CD-ROM.

The process management step includes managing the processes by entering an initial scheduled date, a customer's desired date, a scheduled modification date, and an actual modification date for each of the processes, and wherein the processes are rendered visible depending on specification of the initial scheduled date, the customer's desired date, the scheduled modification date, and the actual modification date.

The artwork development step includes:

a forwarded item registration step of specifying an artwork draft for first proofreading or artwork draft returned after proofreading and registering the artwork draft as item forwarded on the requesting side; and

a draft forwarding step of automatically transmitting the registered artwork draft to the developing side.

The artwork development step includes:

a forwarded item registration step of specifying an artwork draft to be worked on and registering the artwork draft as item forwarded;

a work instruction entry step of entering work instructions related to the registered item forwarded such as proofreading request; and

an approval processing step of approving entered work instructions and automatically transmitting the work instructions to the requesting source.

The artwork development step includes on the developing side,

a forwarded item registration step of specifying an artwork draft to be technical checked and registering the artwork draft as item forwarded; and

a technical check request step of automatically transmitting to the requesting source a technical check for given check items related to the registered artwork draft, and wherein the artwork development step includes on the requesting source,

a forwarded item registration step of specifying an artwork draft whose technical check is requested and registering the artwork draft as item forwarded; and

a technical check notification step of transmitting to the developing side check results in response to technical check request for the registered artwork draft.

The artwork development step includes on the developing side,

a forwarded item registration step of specifying an artwork draft to be delivered and registering the artwork draft as item forwarded; and

a delivery check request step of transmitting to the requesting source a delivery check for given check items related to the registered artwork draft, and wherein the artwork development step includes on the requesting source,

a forwarded item registration step of specifying an artwork draft whose delivery check is requested and registering the artwork draft as item forwarded; and

a delivery check notification step of notifying acceptance or redelivery to the developing side as a delivery check result for the registered artwork draft.

Each of the steps is executed on a server in response to access from either a requesting-source client or a developing client connected via a network and notified to the other client.

The present invention provides a program for manual preparations. The program is operable to cause a computer to execute:

a process simulation step of supporting manual artwork development planning for manual artwork development through simulation of processes from manual preparation request to delivery based on information entered by the requesting side;

a preparation request step of transmitting a manual preparation request prepared by the requesting side to the developing side;

a process management step of accepting the preparation request, acquiring an assigned number, and providing the progress status of processes from draft forwarding to artwork development and bookbinding in a visible manner on the developing side;

an artwork development step of preparing artwork by way of receipt of draft from the requesting side, and editing, proofreading and technical check on the developing and requesting sides; and

a bookbinding/distribution step of delivering a manual by handling bookbinding and/or recording to an electronified medium.

The present invention provides a computer-readable recording medium in which is stored a program for manual preparations. The program stored in the recording medium is operable to cause a computer to execute:

a process simulation step of supporting manual artwork development planning for manual artwork development through simulation of processes from manual preparation request to delivery based on information entered by the requesting side;

a preparation request step of transmitting a manual preparation request prepared by the requesting side to the developing side;

a process management step of accepting the preparation request, acquiring an assigned number, and providing the progress status of processes from draft forwarding to artwork development and bookbinding in a visible manner on the developing side;

an artwork development step of preparing artwork by way of receipt of draft from the requesting side, and editing, proofreading and technical check on the developing and requesting sides; and

a bookbinding/distribution step of delivering a manual by handling bookbinding and/or recording to an electronified medium.

### BRIEF DESCRIPTION OF THE DRAWINGS

FIG. 1 is an explanatory view of a network environment in which the present invention is carried out;

FIG. 2 is a block diagram of server functions of FIG. 1;

FIG. 3 is an explanatory view of a request main menu provided to requesting-side clients by an application server;

FIG. 4 is an explanatory view of a development main menu provided to developing-side clients by the application server;

FIG. 5 is an explanatory view of a series of processing steps by a manual preparation support of the present invention;

FIG. 6 is an explanatory view of the series of processing steps by the manual preparation support of the present invention that continues from FIG. 5;

FIG. 7 is a flowchart of requesting-side processings of the present invention;

FIG. 8 is a flowchart of developing-side processings of the present invention;

FIG. 9 is a flowchart of developing-side processings of the present invention that continues from FIG. 8;

FIG. 10 is an explanatory view of a quotation screen provided to the requesting side by the server of the present invention;

FIG. 11 is an explanatory view of a model screen for manual's draft preparation provided to the requesting side by the server of the present invention;

FIG. 12 is an explanatory view of an XML conversion function provided by the server of the present invention;

FIG. 13 is an explanatory view of embedding of phrase and clause punctuations in XML manual's draft text using a dictionary in FIG. 12;

FIG. 14 is an explanatory view of a manual critical reading/proofreading tool provided by the server of the present invention;

FIG. 15 is a flowchart of requesting-side processings according to the present invention;

FIG. 16 is a flowchart of requesting-side processings according to the present invention that continues from FIG. 15;

FIG. 17 is a flowchart of requesting-side processings according to the present invention that continues from FIG. 16;

FIG. 18 is a flowchart of requesting-side processings according to the present invention that continues from FIG. 17;

FIG. 19 is an explanatory view of a manual preparation requesting screen used on the requesting side;

FIG. 20 is an explanatory view of the manual preparation requesting screen used on the requesting side that continues from FIG. 19;

FIG. 21 is an explanatory view of a basic information entry screen used on the requesting side;

FIG. 22 is an explanatory view of the basic information entry screen that continues from FIG. 21;

FIG. 23 is an explanatory view of the basic information entry screen that continues from FIG. 22;

FIG. 24 is an explanatory view of the basic information entry screen in process simulation on the requesting side;

FIG. 25 is an explanatory view of a condition setting screen in process simulation on the requesting side;

FIGS. 26A and 26B are explanatory views of an initial scheduled date screen in process simulation on the requesting side;

FIG. 27 is a flowchart of process simulation of the present invention;

FIG. 28 is a flowchart of simulation details in FIG. 27;

FIG. 29 is a flowchart of artwork development processings according to the present invention;

FIG. 30 is a flowchart of artwork development processings that continues from FIG. 29;

FIGS. 31A and 31b are flowcharts of artwork development processings that continues from FIG. 30;

FIG. 32 is a flowchart of artwork development processings that continues from FIG. 31B;

FIG. 33 is a flowchart of artwork development processings that continues from FIG. 32;

FIG. 34 is a flowchart of artwork development processings that continues from FIG. 33;

FIGS. 35A and 35B are flowcharts of artwork development processings that continues from FIG. 34;

FIG. 36 is a flowchart of artwork development processings that continues from FIG. 35B;

FIG. 37 is a flowchart of artwork development processings that continues from FIG. 36;

FIG. 38 is a flowchart of artwork development processings that continues from FIG. 37;

FIG. 39 is a flowchart of artwork development processings that continues from FIG. 38;

FIGS. 40A and 41b are flowcharts of artwork development processings that continues from FIG. 39; and

FIG. 41 is a flowchart of artwork development processings that continues from FIG. 40B.

### BEST MODE FOR CARRYING OUT THE INVENTION

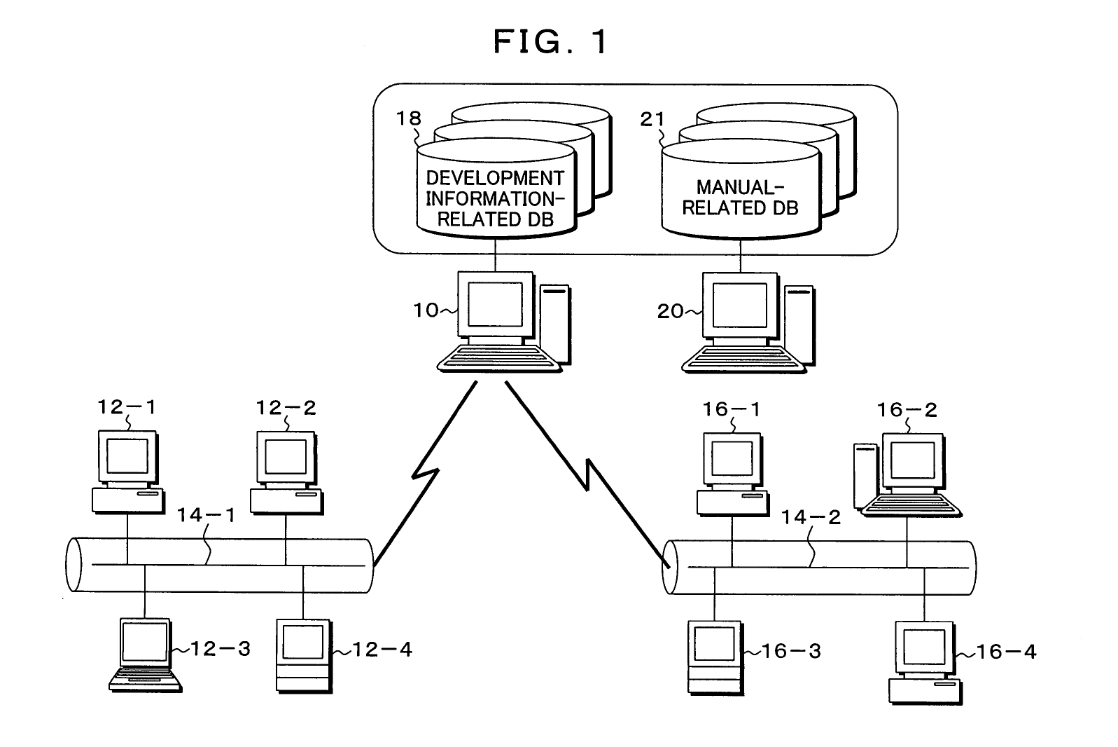

FIG. 1 is an explanatory view of a system configuration to which a manual preparation method of the present invention is applied.

In FIG. 1, a manual development support server 10 is connected to requesting-side clients 12-1 to 12-4, design sources, via a network 14-1, and to developing-side clients 16-1 to 16-4 tasked with artwork development and bookbinding via a network 14-2. The manual development support server 10 is equipped with functions of a web server for exchanging data with the client side, an application server for providing applications for manual development support and further a database server for accessing a development information-related database 18. A manual database server 20 is provided together with the manual development support server 10, with already developed and delivered manual data stored in a manual-related database 21.

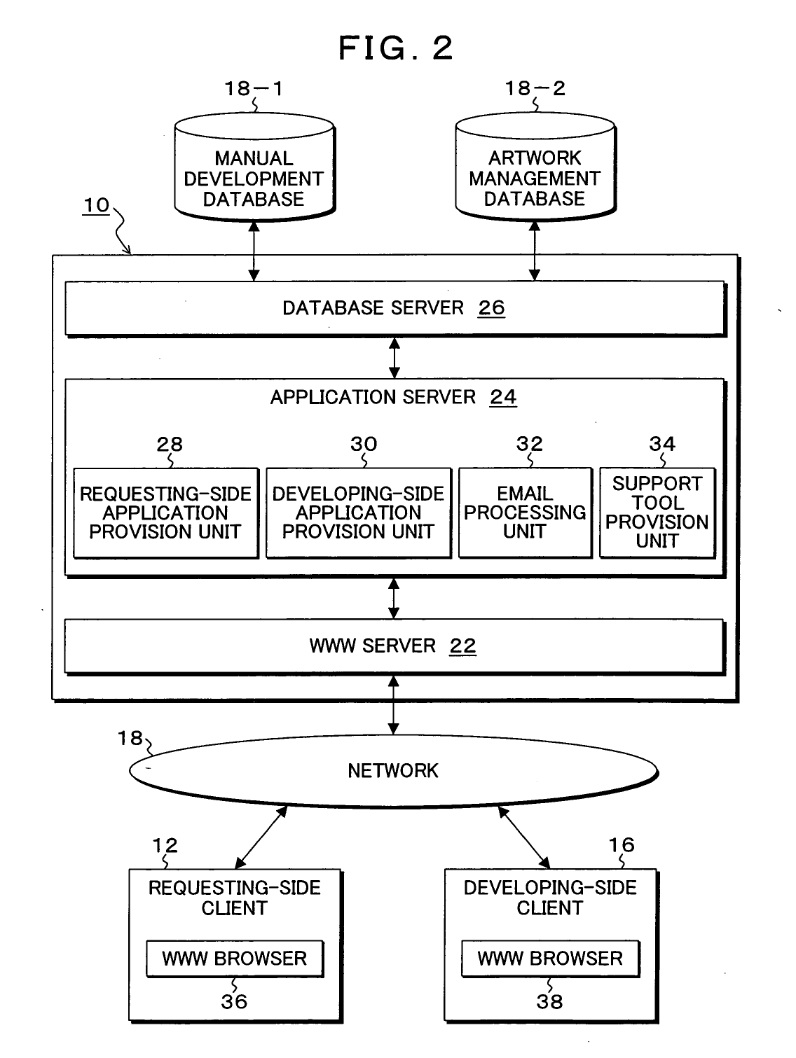

FIG. 2 is a functional block diagram of the manual development support server 10 in FIG. 1 shown together with the client side.

In FIG. 2, the manual development support server 10 is equipped with functions of a WWW server 22, an application server 24 and a database server 26. The WWW server 22 receives commands respectively from a WWW browser 36 of a requesting-side client 12 and from a WWW browser 38 of a developing-side client 16, providing the commands to the application server 24 and transferring a statement and file, output in correspondence with the commands, to the client side.

There are connected a manual development database 18-1 and an artwork management database 18-2, both making up the development information-related database 18, to the database server 26. The manual development database 18-1 stores a development information table, responsible staff member information table, project information table, subcontractor information table, artwork management table and so on. On the other hand, the artwork management database 18-2 has developed manual data registered therein.

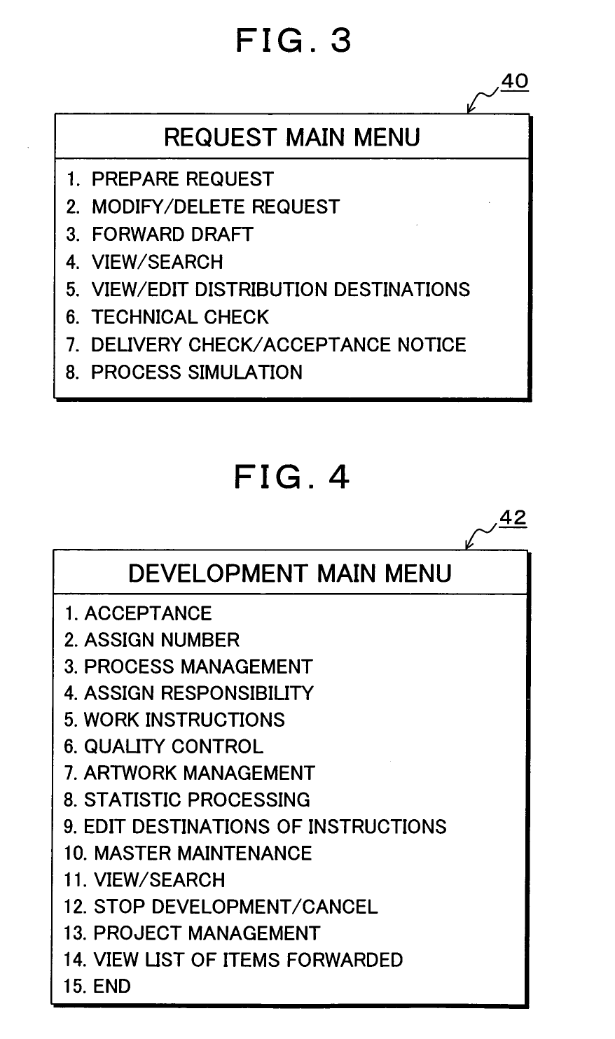

The application server 24 is provided with a requesting-side application provision unit 28, a developing-side application provision unit 30, an email processing unit 32 and a support tool provision unit 34. The requesting-side application provision unit 28 provides a request main menu 40 shown in FIG. 3 in response to access from the requesting-side client 12. The request main menu 40 is organized with menu options as follows:
1 Prepare request
2 Modify/delete request
3 Forward draft
4 View/search
5 View/edit distribution destinations
6 Technical check
7 Delivery check/acceptance notice
8 Process simulation

The developing-side application provision unit 30 provides a development main menu 42 shown in FIG. 4 in response to access from the developing-side client 16. The development main menu 42 is organized with menu options as follows:
1. Acceptance
2. Assign number
3. Process management
4. Assign responsibility
5. Work instructions
6. Quality control
7. Artwork management
8. Statistic processing
9. Edit destinations of instructions
10. Master maintenance
11. View/search
12. Stop development/cancel
13. Project management
14. View list of items forwarded
15. End
   For this reason, the design side that requests manual artwork development, electronification and bookbinding, i.e., the requesting-side client 12 selects necessary menu options from among the request main menu 40, thus requesting manual artwork development, electronification and bookbinding to the developing side. In response to the request from the requesting side—the design source, the artwork development side, i.e., the developing-side client 16 selects menu options in accordance with a series of development steps from among the development main menu 42 in FIG. 4, thus performing necessary tasks.

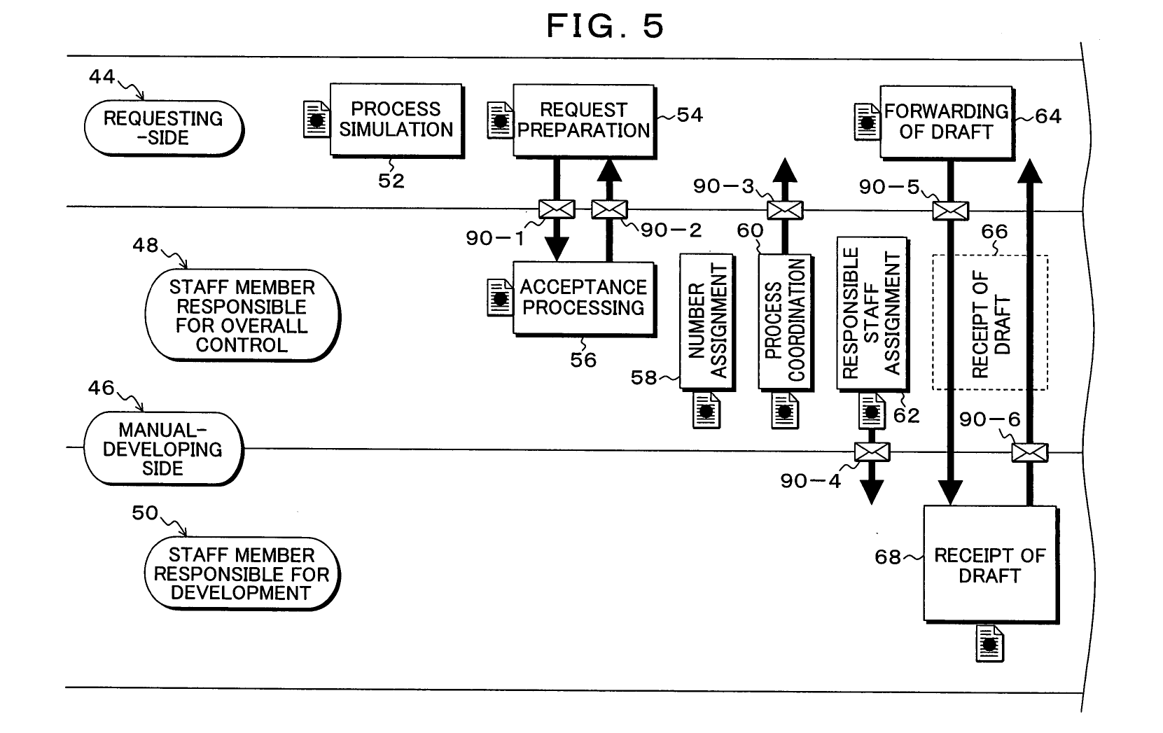

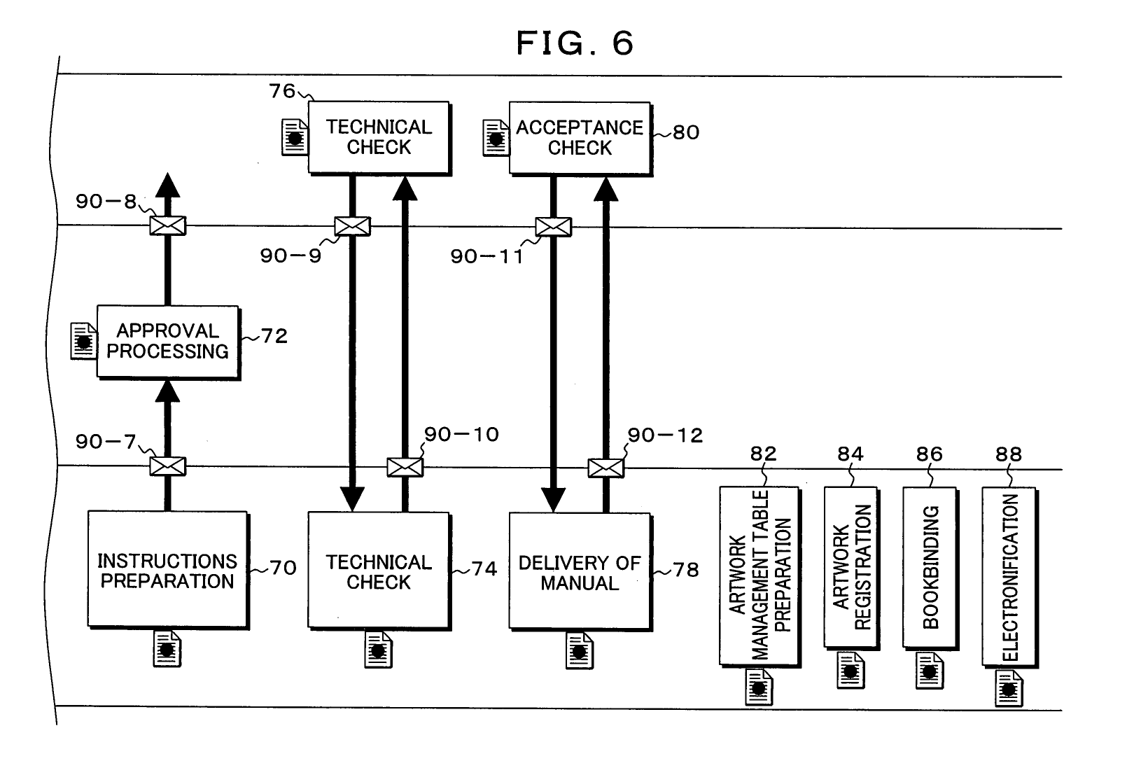

FIGS. 5 and 6 are explanatory views of a series of processing steps according to the present invention from artwork development to electronification, bookbinding and printing. In FIG. 5, a requesting side 44 tasked with hardware product development prepares a development plan for manual artwork preparation and electronification/bookbinding through a process simulation 52, thus establishing the optimal development processes. When the development plan using the process simulation 52 is established, the requesting side 44 makes a preparation request 54 to a manual-developing side 46. The preparation request 54 is transmitted to a staff member responsible for overall control 48 on the manual-developing side 46 where an acceptance processing 56 is performed. In the acceptance processing 56, when the preparation request is accepted, acceptance result is transmitted to the requesting side 44 with an email 90-2. On the manual-developing side 46 that has accepted the preparation request, the staff member responsible for overall control 48 next proceeds with a number assignment 58 in which a number is assigned to the accepted request. Then, the staff member responsible for overall control 48 performs a process coordination 60 in relation to results of the process simulation 52—the coordination in which processes on the developing side are coordinated, transmitting coordination results to the requesting side 44 with an email 90-3. When the process coordination 60 is complete, a responsible staff assignment 62 is performed for a staff member responsible for development on the manual-developing side 46, transmitting the preparation request—a request that has been subjected to the acceptance, the number assignment and the process coordination—to a staff member responsible for development 50 with an email 90-4.

After receipt of the responsible staff assignment 62, the staff member responsible for development 50 waits for a forwarding of draft 64 from the requesting side 44. In response to receipt of coordination results of the process coordination 60 with the email 90-3, the requesting side 44 prepares a draft based on a draft forwarding deadline shown in the development processes, performing a forwarding of draft 64 with an email 90-5. The draft transmitted with the email 90-5 is subjected to a receipt of draft 66 by the staff member responsible for overall control 48 on the manual-developing side 46 first, and redirected to the staff member responsible for development 50 for a receipt of draft 68. When the receipt of draft 68 is complete, an email 90-6 is transmitted to the requesting side 44 to confirm receipt of the draft.

In response to receipt of the draft from the requesting side 44, the staff member responsible for development 50 proceeds with artwork development tasks such as writing, translation and editing. More specifically, the staff member responsible for development 50 handles an instructions preparation 70 related to work instructions after the receipt of draft 68 and then transmits instructions to the staff member responsible for overall control 48 with an email 90-7 for an approval processing 72, after which the staff member responsible for development 50 transmits the work instructions to the requesting side 44 with an email 90-8. In the course of artwork development tasks based on the received draft, the staff member responsible for development 50 performs a technical check 74 when an artwork draft is complete, requesting proofreading of the draft to the requesting side 44 with an email 90-9. In response to the email 90-9, the requesting side 44 performs a technical check 76 of the draft to be proofread in which necessary changes and additions are made, and then returns the proofread artwork draft to the staff member responsible for development 50 on the manual-developing side 46 with an email 90-10 as a returned draft after proofreading. Proofreading request and return of the proofread draft by the staff member responsible for development 50 and the requesting side 44, as shown by the technical checks 74 and 76, are exchanges using the emails 90-9 and 90-10, making it extremely easy to request draft proofreading and return a proofread draft. In development processings of the present invention, the number of times of proofreading can be set in advance at the time of the process simulation 52 and the process coordination 60. Proofreading request is made and the proofread draft is returned within the number of times set in advance, unless it is problematic.

Completion of the artwork draft—through the technical checks 74 and 76 involving proofreading request and return of the proofread draft—is followed by a delivery of manual 78 to the requesting side 44 with an email 90-11. The requesting side examines the delivered manual for an acceptance check 80, transmitting a check result to the staff member responsible for development 50 with an email 90-12. When there are no problems with the delivered manual, acceptance is notified as check result. In the presence of imperfection, rejection is notified as check result. In this case, the staff member responsible for development 50 returns again to the technical check 74, going through proofreading request and return of the proofread draft. Then, the staff member responsible for development 50 performs the delivery of manual 78, acquiring an acceptance result from the acceptance check 80. When acceptance is obtained as check result in response to the delivery of manual 78, the staff member responsible for development 50 proceeds with an artwork management table preparation 82 first and then with an artwork registration 84 in which the prepared manual artwork is registered in a database. Then, the staff member responsible for development 50 proceeds with a bookbinding 86 and further an electronification 88 for creating RAM, thus ending a series of development tasks.

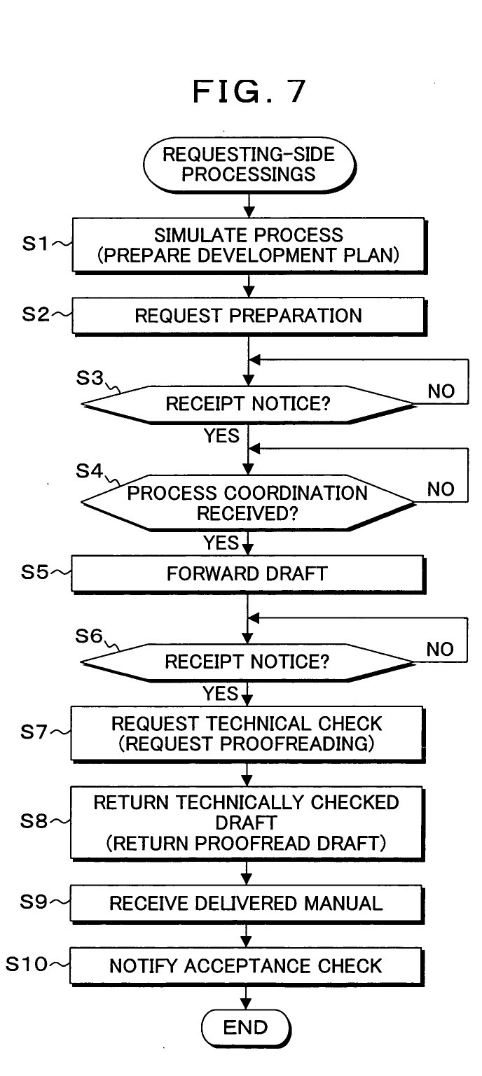

FIG. 7 is a flowchart of requesting-side processings by the WWW browser 36 of the requesting-side client 12 in FIG. 2 using the request main menu 40 in FIG. 3. In the requesting-side processings, a development plan is prepared through process simulation at Step S1. Next, the preparation request is made at Step S2, and if receipt is notified at Step S3, the process coordination is received at Step S4. Then, at Step S5, the draft is forwarded in accordance with the coordinated processes, and then if receipt is notified at Step S6, a technical check request is accepted as proofreading request from Step S7. In response to the technical check request, the requesting side proofreads the contents of the artwork draft through critical reading, returning the technical checked draft as return of the proofread draft at Step S8. Technical check request and return of the technical checked draft at Steps S7 and S8 are repeated several times. When the artwork draft is complete as a result of technical check request and return of the technical checked draft, manual delivery is received at Step S9. After examination of the contents, acceptance check is notified at Step S10. Rejection is notified in the event of modifications or changes to the artwork delivered. In response, processings are repeated again from Step S7.

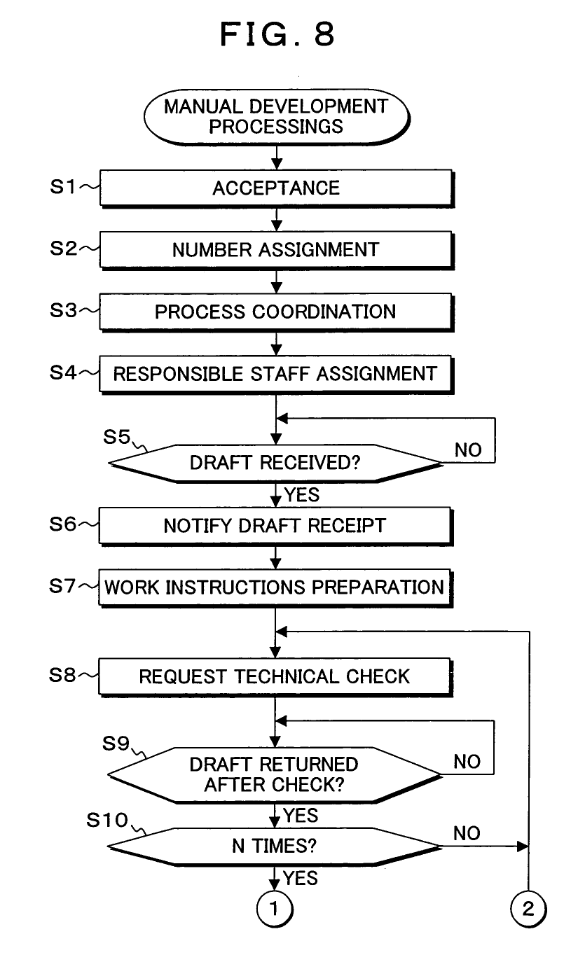

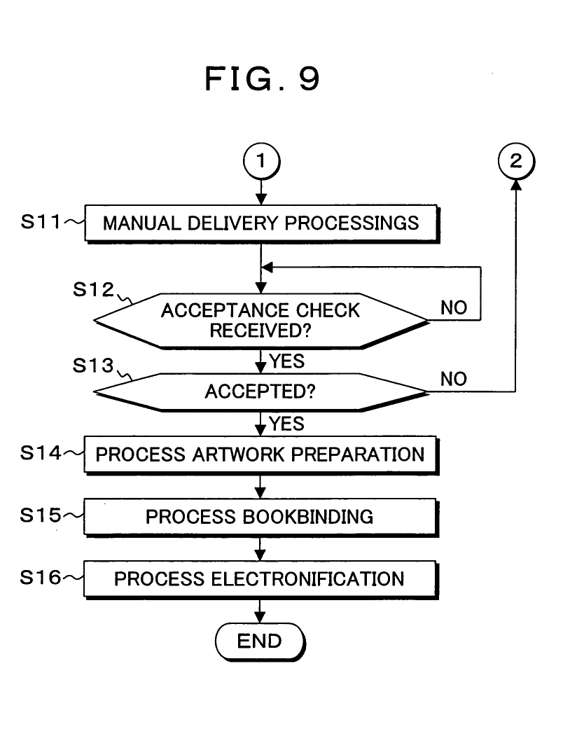

FIG. 8 is a flowchart of manual development processings by the WWW browser 38 of the developing-side client 16 in FIG. 2 using the development main menu 42 in FIG. 4 provided by accessing the manual development support server 10. In the manual development processings, acceptance processing by the developing side at Step S1 is followed by number assignment processing at Step S2 and process coordination processing at Step S3, after which responsible staff assignment is handled at Step S4. Then, the developing side waits for receipt of draft from the requesting side at Step S5. When the draft is received, the developing side notifies receipt of the draft at Step S6 and then processes work instructions preparation at Step 7, communicating the result to the developing side with an email. Then, the staff member responsible for development proceeds with artwork development tasks such as writing, translation and editing, and, when the artwork draft is complete, makes a technical check request at Step S8 for proofreading of the draft. If it is discovered at Step 9 that the checked draft is returned as proofread draft from the requesting side in response to the technical check request, the process proceeds to Step S10 where it is checked whether the number of times of proofreading reaches N times. If the number of times of proofreading is less than N times, the staff member responsible for development makes modifications/changes correspondingly with the returned proofread draft, and makes a technical check request again at Step S8 to return the proofread draft. When the number of times of proofreading reaches N times at Step S10, the staff member responsible for development makes modifications/changes correspondingly with the returned proofread draft first and then performs manual delivery processing at Step S11 by regarding the artwork draft as a completed draft as this is the final proofreading. Since the requesting side conducts acceptance check on the manual delivery, it is checked at Step S12 in FIG. 9 whether acceptance check is received from the requesting side. When acceptance check is received, it is checked at Step S13 whether the delivered manual is accepted. In the event of rejection, the process returns to Step S8 in FIG. 7 where the artwork draft is modified/changed and then processings are repeated from the technical check. When the delivered manual is accepted at Step S13, the staff member responsible for development proceeds with artwork preparation processing at Step S14 and bookbinding processing at Step S15, after which electronification processing is performed at the end at Step S16 in which CD-ROM is created.

The above are the manual preparation processings handled by the requesting-side application provision unit 28 and the developing-side application provision unit 30 in the application server 24 provided in the manual development support server 10 in FIG. 2. In this series of manual preparation processings, the email processing unit 32 provided in the application server 24 functions as a mailer for the requesting-side client 12 and the developing-side client 16, handling statement and file transfer using emails.

Further, the application server 24 is provided with the support tool provision unit 34. Among support tools provided by the support tool provision unit 34 are as follows:
(1) Manual bookbinding/printing quotation tool
(2) Manual draft preparation tool providing model
(3) Dictionary tool for embedding phrase/clause punctuations in XML manual documents
(4) Manual critical reading/proofreading tool

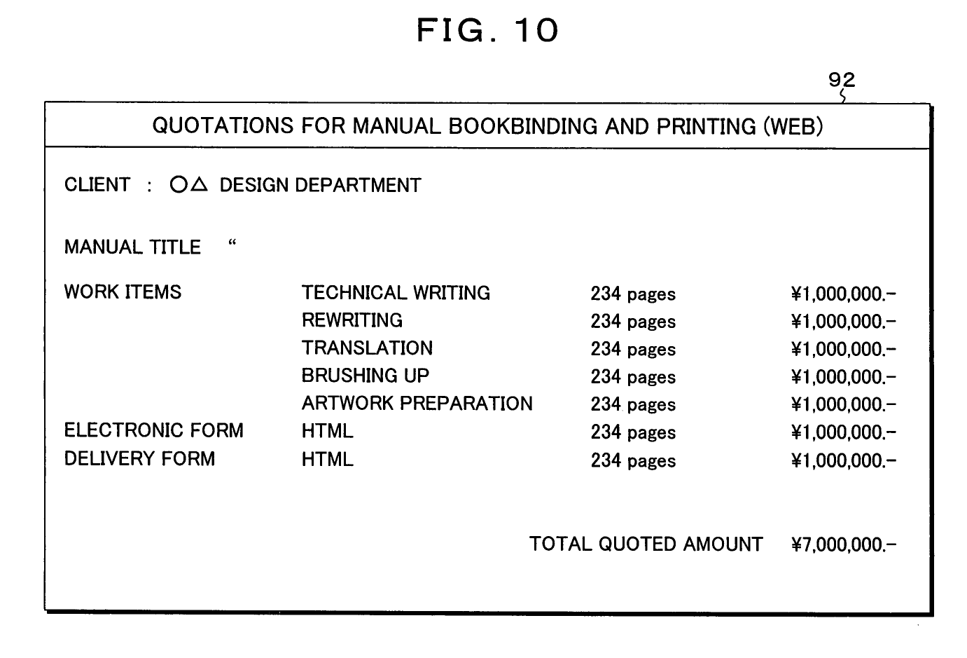

FIG. 10 is a tool screen 92 of a quotation tool for manual bookbinding/printing provided to the requesting-side client 12 by the support tool provision unit 34. In response to a quotation request, the tool screen 92 calculates the number of pages to be prepared and a quoted amount for each of the work items and for electronic form and delivery form and provides a total quoted amount at the end.

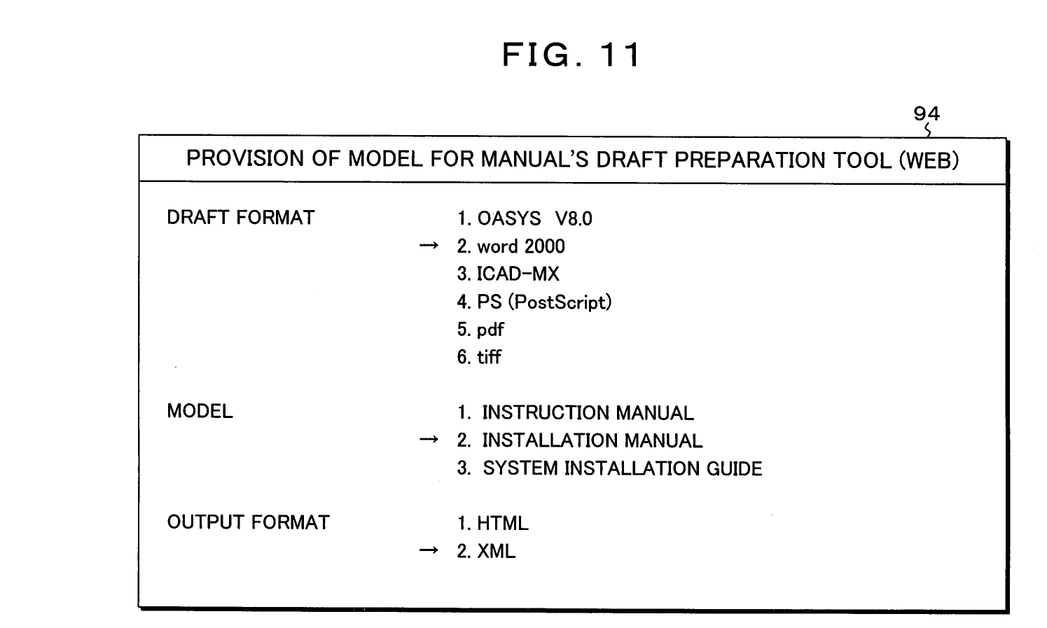

FIG. 11 is a tool screen 94 of a manual draft preparation tool for providing model provided to the requesting-side client 12 by the support tool provision unit 34. In the tool screen 94, draft format, model and output format are set to obtain a model. In this example, “Word2000”, “Illustration Manual” and “XML” are set respectively for draft format, model and output format. Thus, provision of a model by the draft preparation tool on the developing side allows speedy and proper preparation of a draft for a variety of manuals that need to be developed.

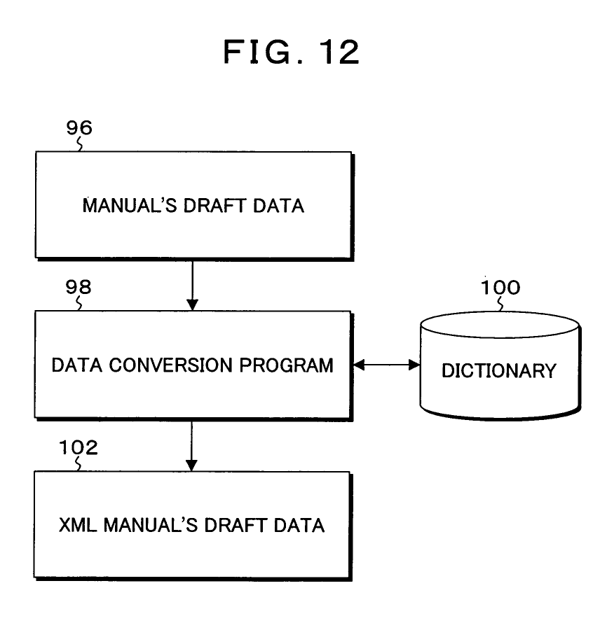

FIG. 12 is a block diagram of tool functions, used on the developing side to embed phrase and clause punctuations in a XML-formatted manual document, provided by the support tool provision unit 34. In FIG. 12, if manual's draft data 96 received by the developing-side client 16 is in a data format such as “Word2000” and the data format requested in the artwork development is XML, the manual's draft data 96 is converted to manual's XML draft data 102 by a data conversion program 98. To ensure consistency in phrase and clause punctuations of the converted manual document in XML format at the time of conversion to the manual's XML draft data 102 by the data conversion program 98, phrase and clause punctuations are embedded through comparison with the contents of a dictionary 100 by selecting a similar menu.

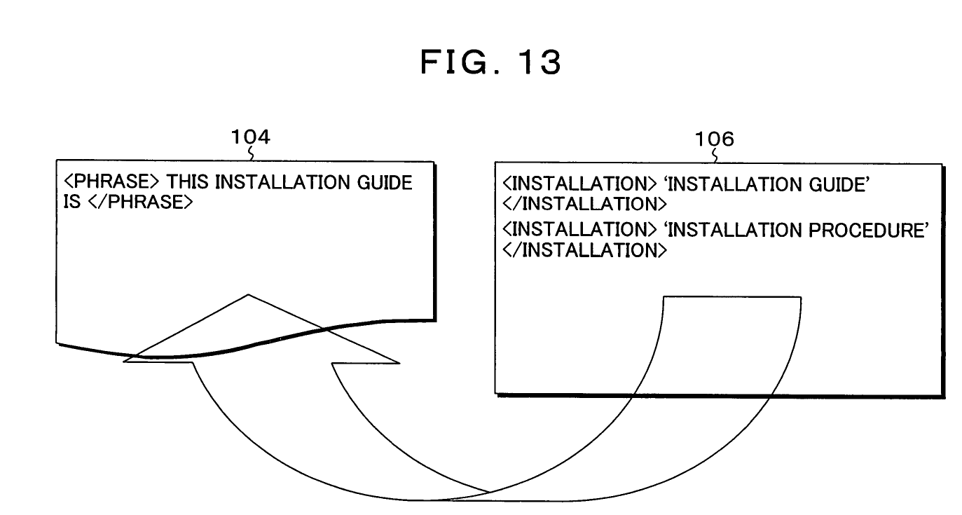

FIG. 13 is a specific example of embedding of phrase and clause punctuations in an XML-formatted manual document by FIG. 12. In FIG. 13, “<phrase> This installation guide is </phrase>” is in an XML manual draft 104. When one searches the dictionary 100 and opens a dictionary popup menu 106 on screen for such a phrase, the following are shown as similar menus:
“<installation> ‘Installation guide’ </installation>”
“<installation> ‘Installation procedure’ </installation>”
   In this case, therefore, the punctuations shown in the popup menu 106 are embedded as punctuations of the XML manual draft 104. This allows similar phrases and clauses in XML manual documents to be punctuated in the same manner, thus standardizing the structural format of XML documents through commonization of punctuations.

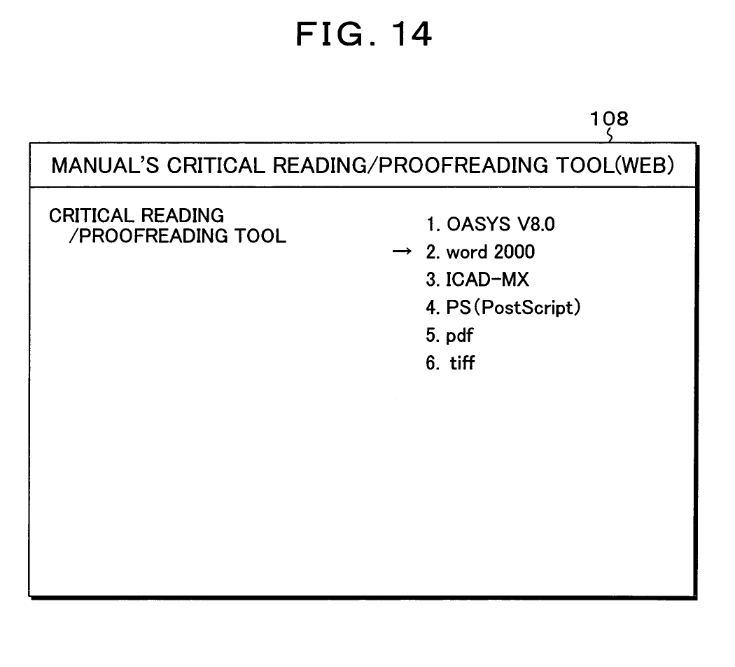

FIG. 14 is a manual's critical reading/proofreading tool provided to the requesting side by the support tool provision unit 34 of the application server 24. The manual's critical reading/proofreading tool allows critical reading and proofreading of the corresponding draft, for example, by selecting “Word2000.” As a manual's critical reading tool, the manual draft is output, for example, by an operator through audio output. Manual's proofreading tool, on the other hand, allows freehand proofreading with a red pen on the draft screen, facilitating developing-side review during discussions of the contents of the draft for requested proofreading and enabling easy confirmation of the contents of developing-side proofreading in the returned draft.

Next, a detailed description will be given of requesting-side processings using the request main menu 40 in FIG. 3 in an access to the manual development support server 10 from the requesting-side client 12 in FIG. 2.

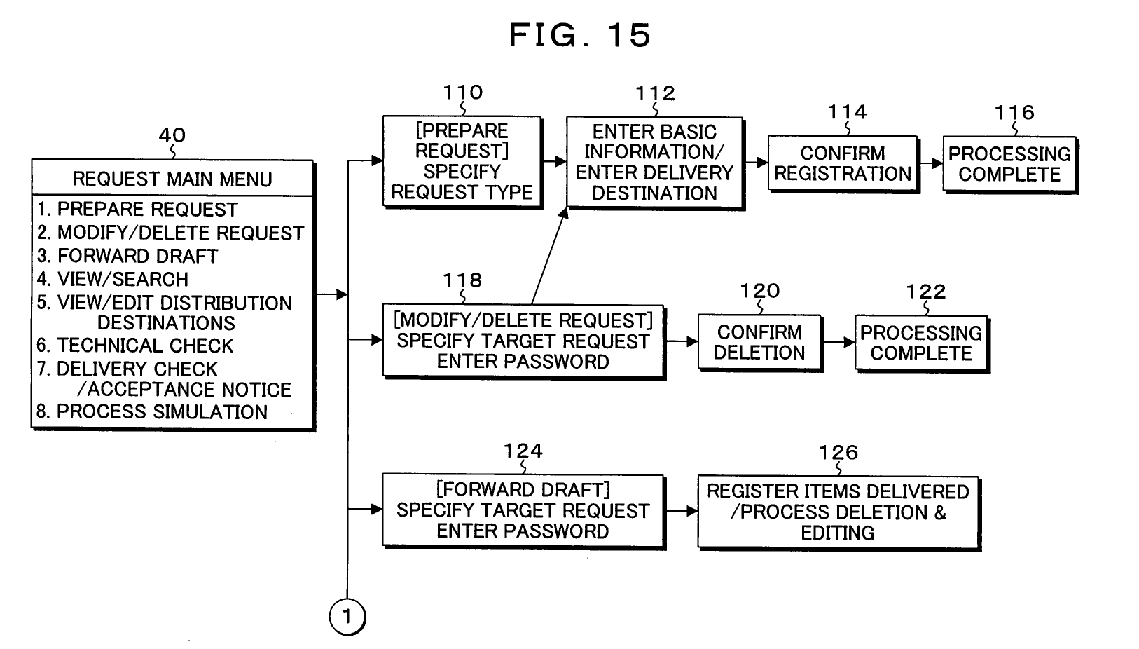

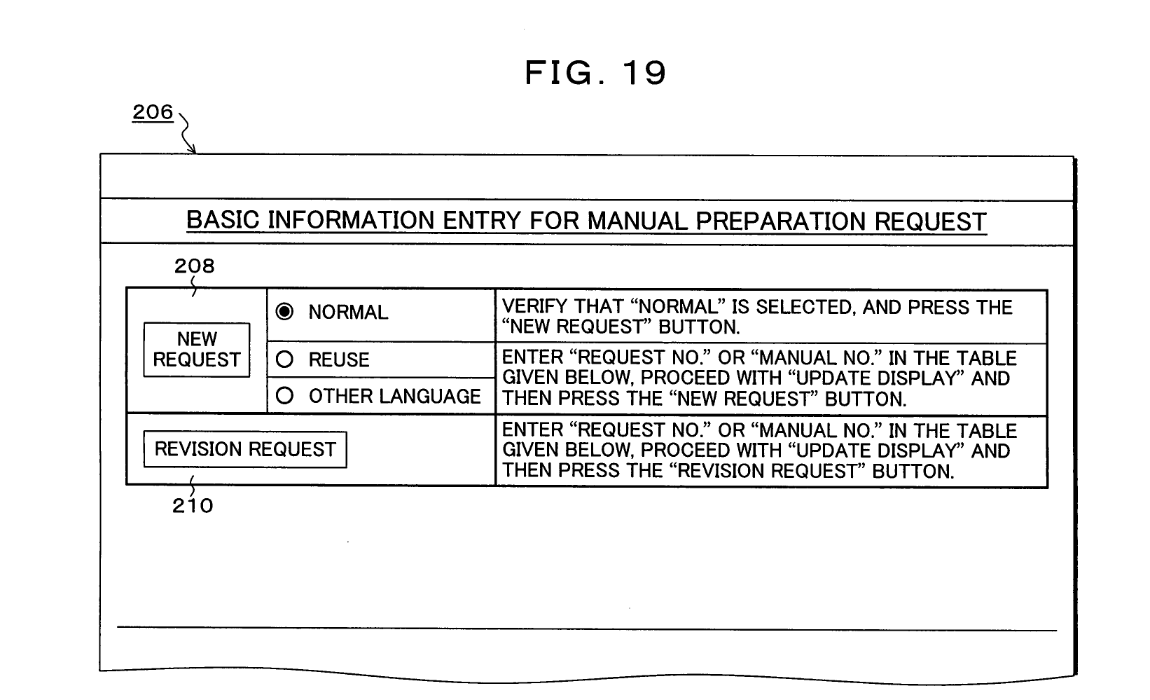

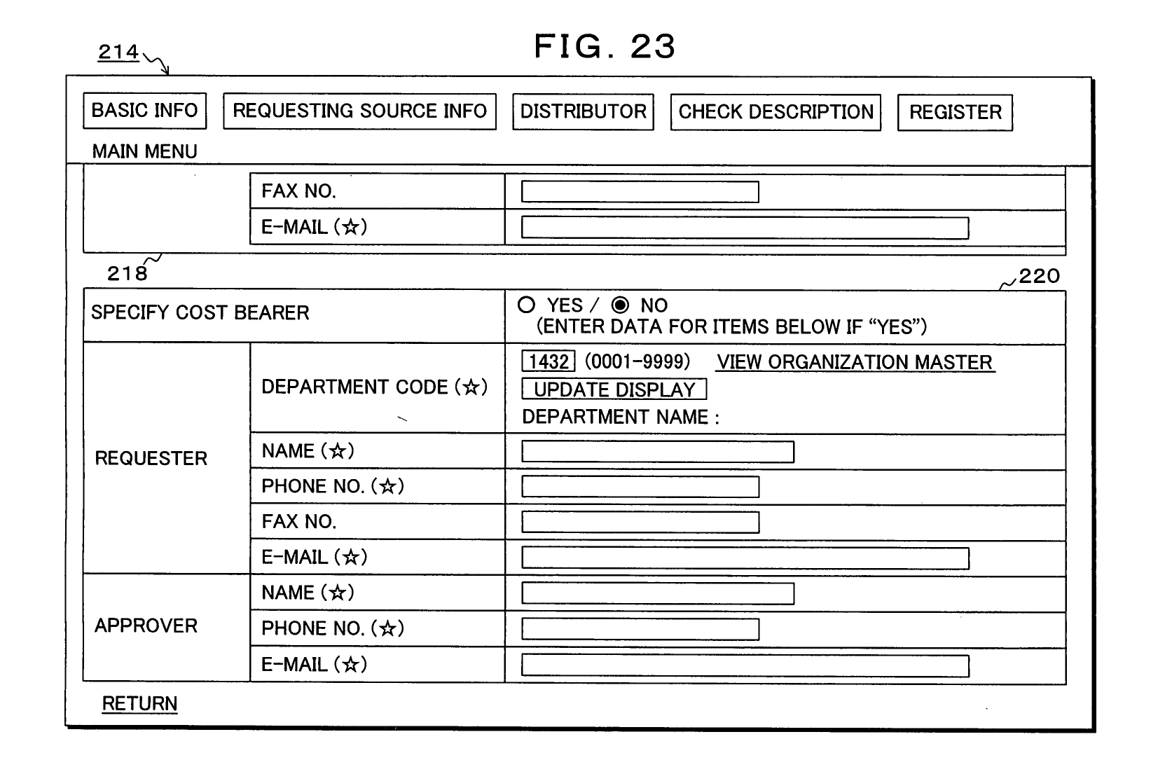

FIGS. 15 to 18 are a flowchart of how screen changes take place when each of the menu options in the request main menu 40 shown on the left side of the FIG. 15 is selected. First, when “1. Prepare request” is selected, the screen changes to a screen 110 where a request type is specified. When a request type is specified, the screen changes to a screen 112 where one enters basic information or delivery destination. Then, the screen changes to a registration confirmation screen 114. After registration confirmation, the screen changes to a processing complete screen 116. Details of the screens 110 to 116, displayed when “1. Prepare request” is selected in the request main menu 40, are shown in FIGS. 19 to 23.

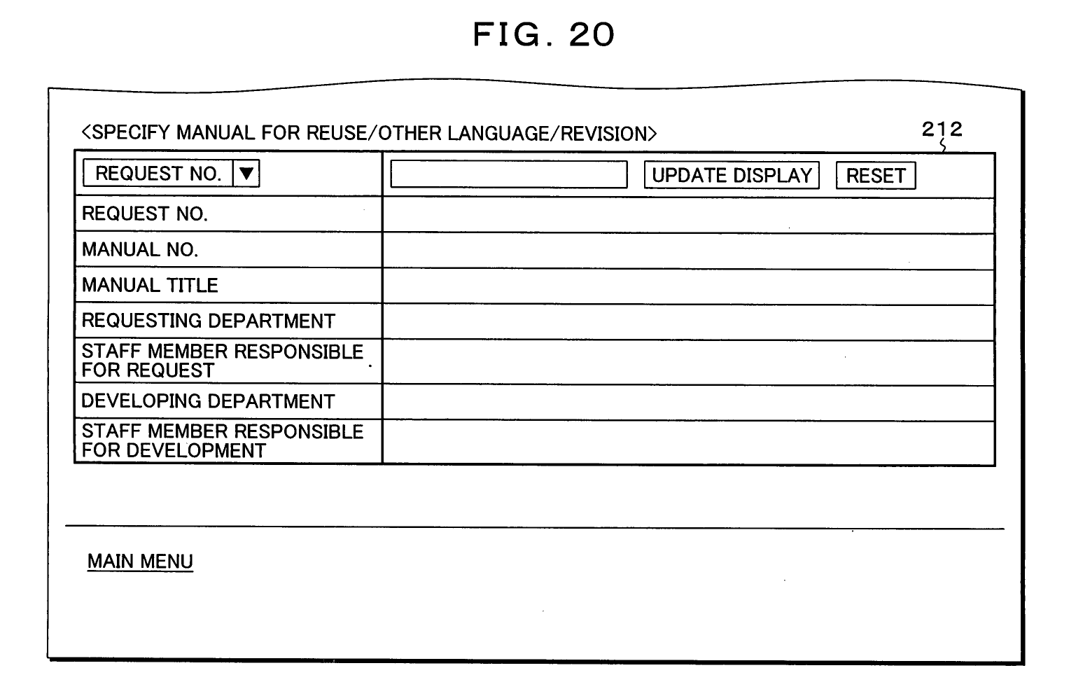

FIGS. 19 and 20 are a specific example of a manual preparation request screen used on the requesting side. In the manual preparation request screen, one can specify either a new request 208 or a revision request 210. In the case of the new request 208, “Normal”, “Reuse” or “Other language” is specified. When “Normal” is selected, one needs only to press the new request 208 button. When “Reuse” or “Other language” is selected, one enters a request number or manual number in a table 212 shown below and updates the display, and then presses the new request 208 button. In the case of the revision request 210, on the other hand, one needs only to enter a request number or manual number in the table 212 shown below and update the display, and then press the revision request 210 button.

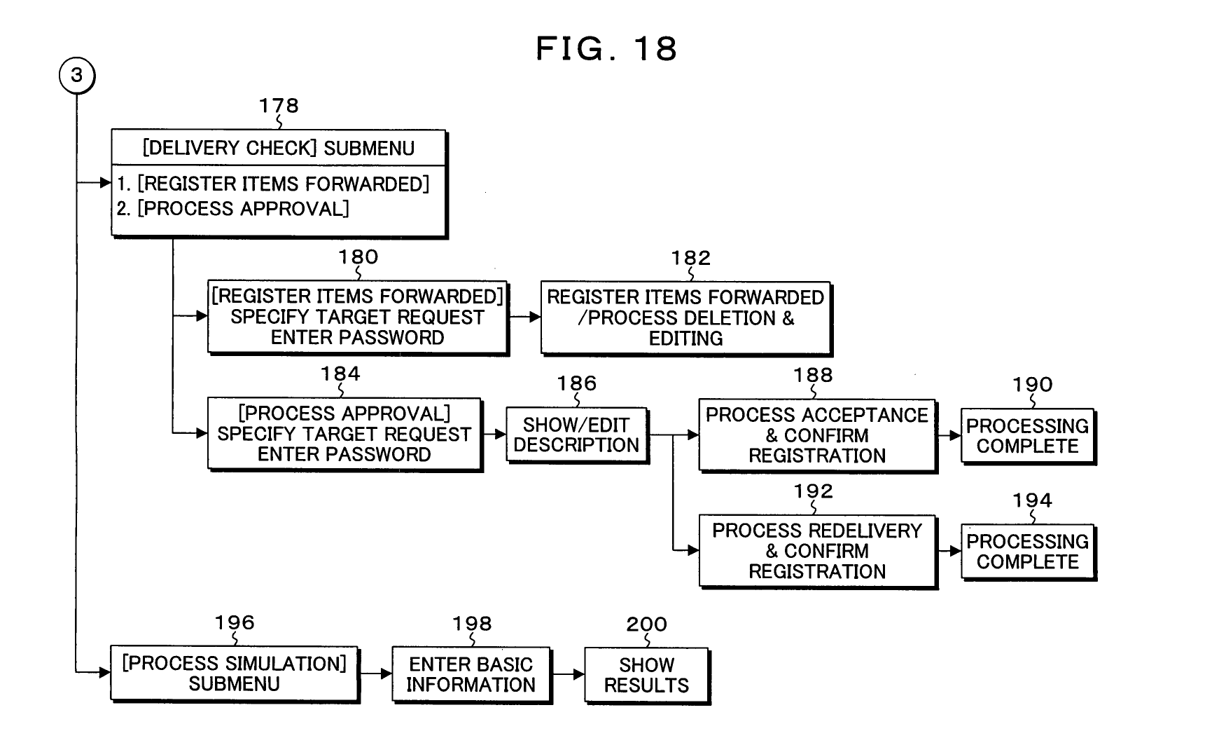

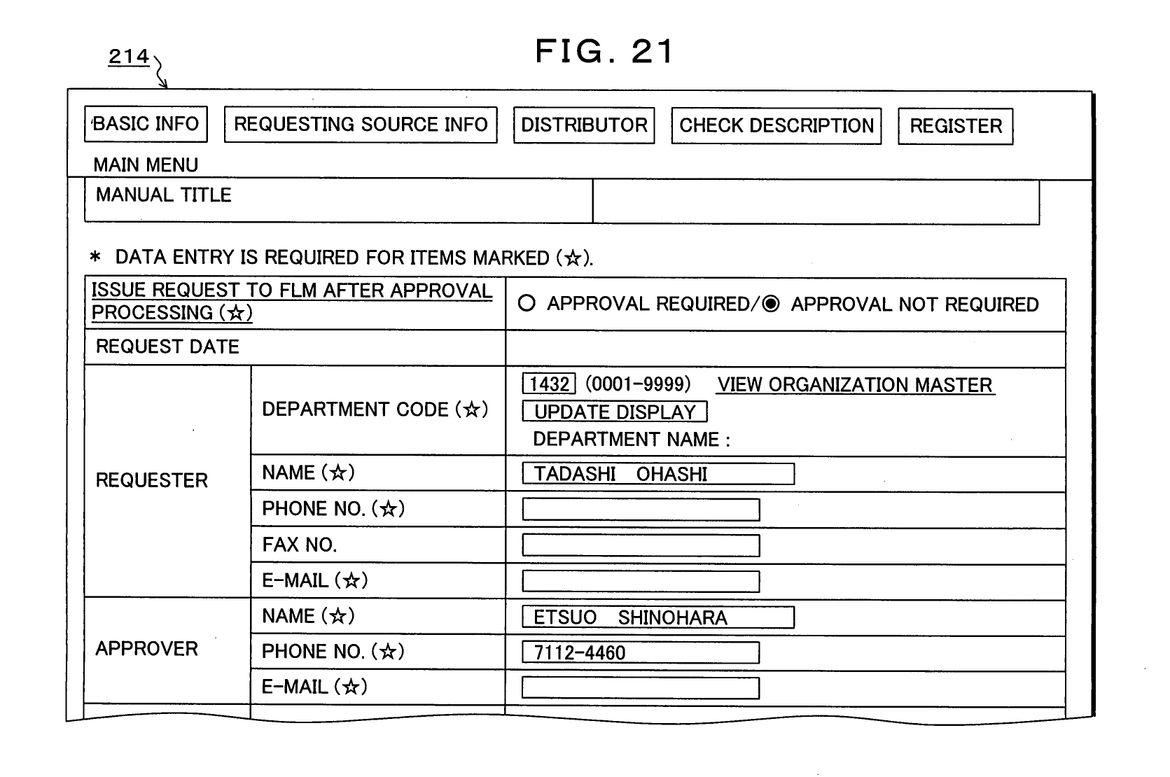

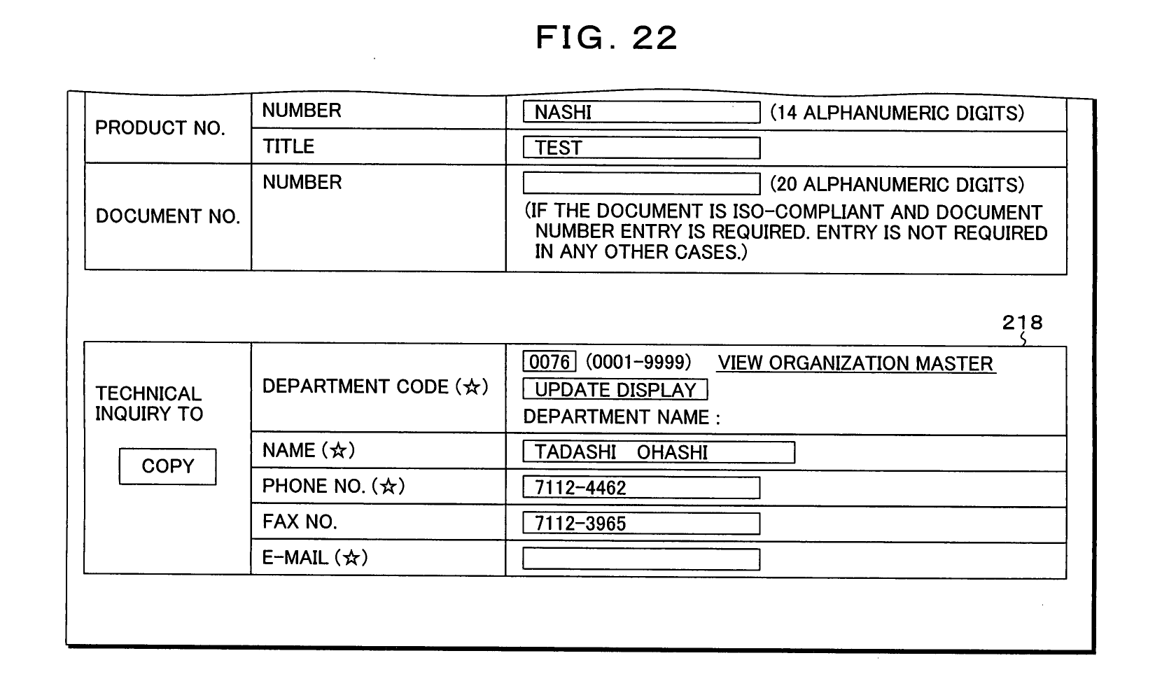

FIGS. 21 and 22 are a specific example of a screen 214 for basic information entry attendant on the manual preparation request. In the basic information entry screen, a given entry field is defined for each of requester, approver, product number and document number as basic information. Next, one can enter data for a destination of technical inquiry 218 and further enter data for a cost bearer specification 220 in FIG. 18.

Referring back to FIG. 15, when “2 Modify/delete request” is selected, the screen changes to a screen 118 where one specifies a target request and enters a password. In the case of request modification, the screen changes to the screen 112 where one enters basic information or delivery destination. Then, one confirms registration in the screen 114, thus changing the screen to the processing complete screen 116. In the case of request deletion, on the other hand, one confirms deletion in a screen 120, thus changing the screen to a processing complete screen 122.

When “3 Forward draft” is selected in the request main menu 40, the screen changes to a screen 124. When one specifies a target request and enters a password, the screen changes to a screen 126 where one can proceed with editing such as registering a draft to be forwarded as an item forwarded or deleting a draft. If the draft is registered as item forwarded in the screen 126, the email processing unit 32 in FIG. 2 will automatically transmit the draft to the developing side with an email.

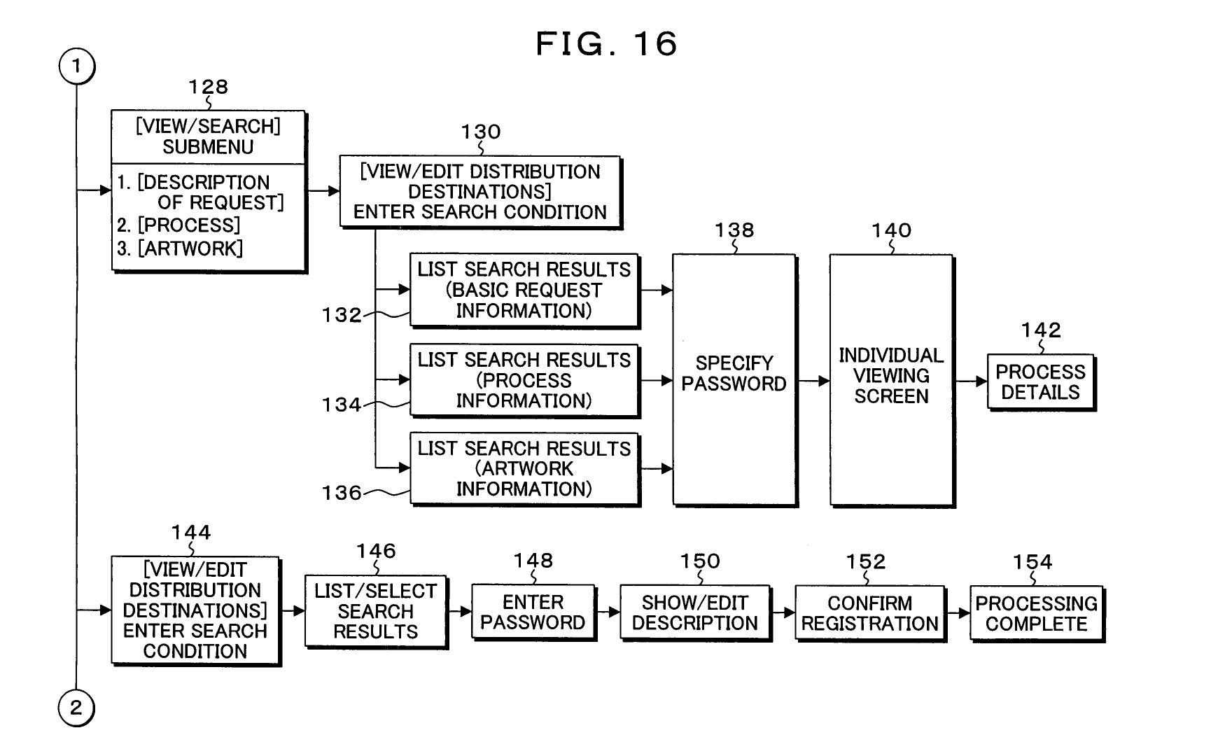

Next, when “4 View/search” is selected in the request main menu 40, the screen changes to a submenu in a screen 128 of FIG. 16. The view/search submenu allows viewing and search through each of [Description of request], [Process] and [Artwork]. When one of the options is searched in the submenu, the screen changes to a screen 130 where one enters a search condition. In response to entry of the search condition, basic request information is shown as a search result list in a screen 132 when [Description of request] is selected in the submenu. When [Process] is selected in the submenu, the screen changes to a screen 134 where process information is shown as a search result list. Further, when [Artwork] is selected in the submenu, artwork information is shown in a screen 136 as a search result list. For any of the screens 132, 134 and 136, if one specifies a password in a following screen 138, an individual viewing screen is shown in a screen 140, and one can display process details in a screen 142 from the viewing screen. When the process details are shown, the description of each process is displayed in a visible manner as shown later in process simulation.

Next, when “5 View/edit distribution destinations” is selected in the request main menu 40 of FIG. 15, the screen changes to a screen 144 in FIG. 16 where one enters a search condition. When the search condition is entered, the screen changes to a screen 146 for listing/selecting search result. When one enters a password in a screen 148, the screen changes to a screen 150 for showing/editing description. When confirmation of the description or editing through display is finished, the processing is complete in a screen 154 after registration confirmation in a screen 152.

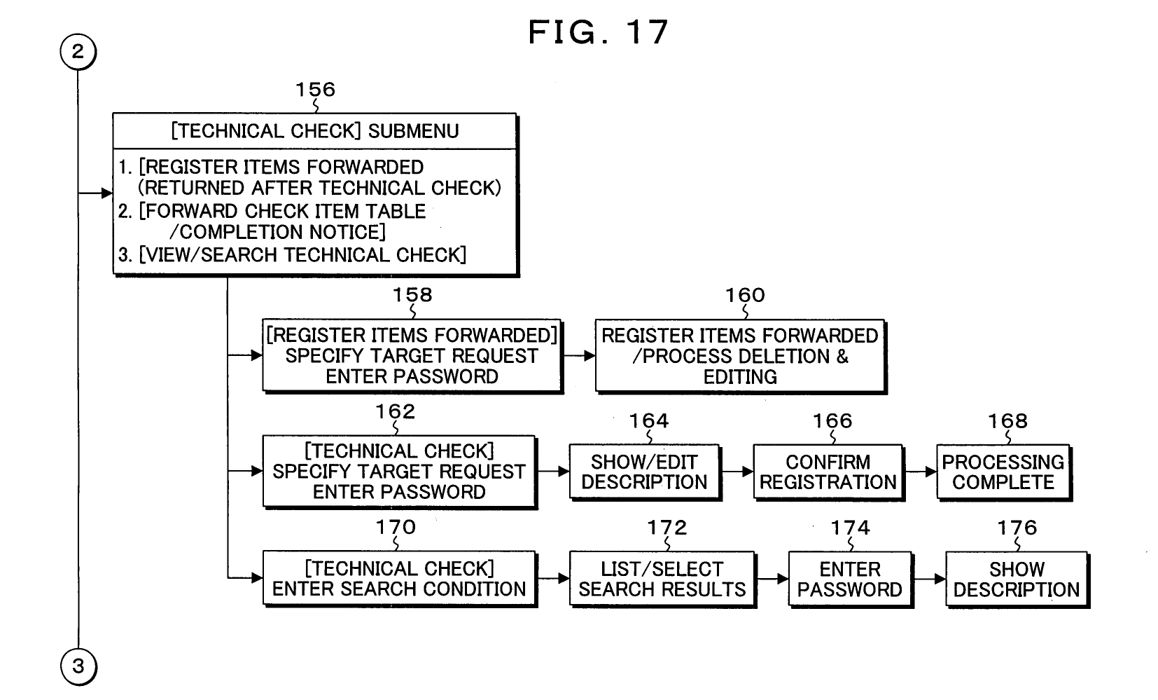

Next, when “6 Technical check” is selected in the request main menu 40 of FIG. 15, the screen changes to a screen 156 in FIG. 17 where a submenu is displayed. The submenu contains three options, namely, [Register items forwarded (returned after technical check)] [Forward check item table/completion notice] and [View/search technical check]. When [Register items forwarded (returned after technical check)], a first option, is selected, the screen changes to a screen 158. When one enters a password in the screen 158, the screen changes to a screen 160 for registering items forwarded/processing deletion and editing for the draft whose proofreading is requested. When [Forward check item table/completion notice], a second option in the submenu, is selected, the screen changes to a screen 162. When one enters a password in the screen 162, the screen changes to a screen 164 for showing/editing description. The processing is complete in a screen 168 after registration confirmation in a screen 166. Further, when [View/search technical check], a third option in the submenu, is selected, the screen changes to a screen 170. When one enters a password in the screen 170, the screen changes to a screen 172 for listing/selecting search result. When one enters a password in a screen 174, the description is displayed in a screen 176.

Next, when “7 Delivery check/acceptance notice” is selected in the request main menu 40 of FIG. 15, the screen changes to a screen 178 in FIG. 18 where a submenu is displayed. The submenu contains two options, namely, [Register items forwarded] and [Process approval]. When [Register items forwarded] is selected in the submenu, the screen changes to a screen 180. When one enters a password in the screen 180, the screen changes to a screen 182 where one can register items forwarded or process deletion and editing. When [Process approval] is selected in the submenu, the screen changes to a screen 184. When one specifies a target request and enters a password, it is possible to show and edit the description in a screen 186. In the case of acceptance as approval result, one processes acceptance and confirms registration in a screen 188, and the processing is complete in a screen 190. In the case of rejection, on the other hand, the processing is complete in a screen 194 after processing of redelivery and registration confirmation in a screen 192.

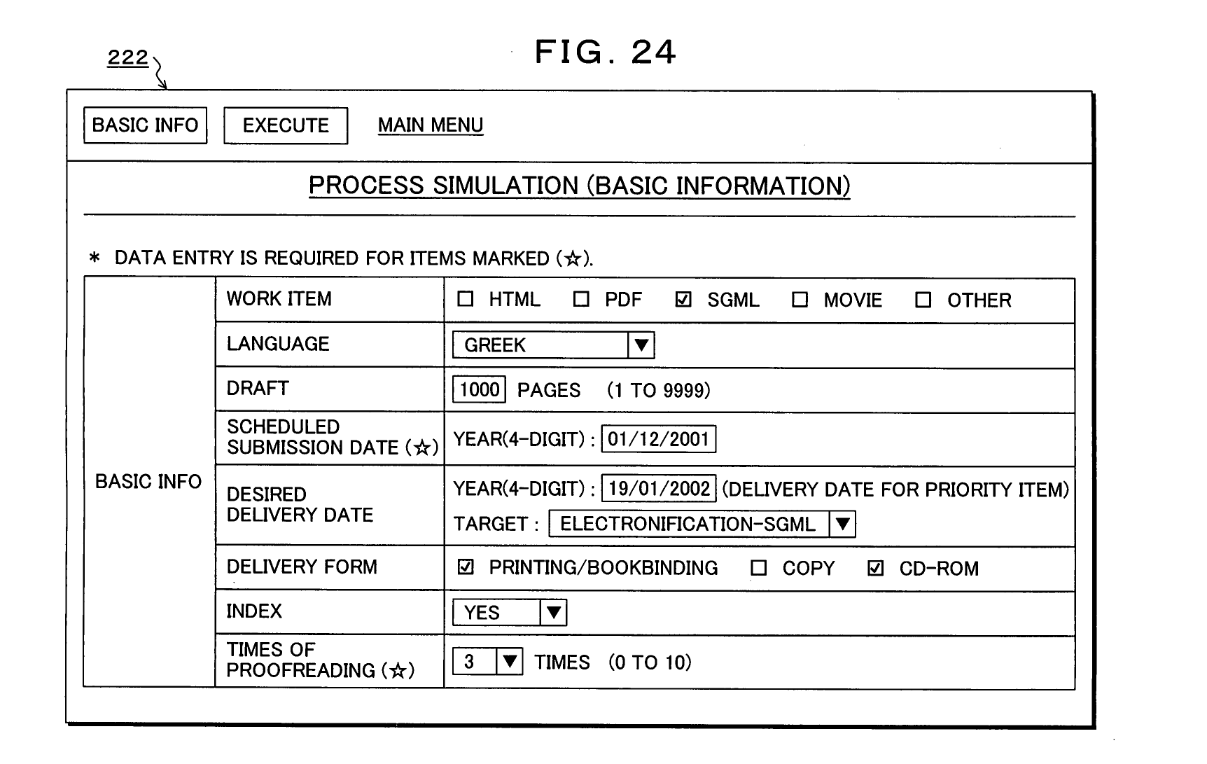

Next, when “8 Process simulation” is selected in the request main menu 40 of FIG. 15, the screen changes to a submenu in a screen 196 of FIG. 18. Then, when one enters basic information and performs simulation in a screen 198, simulation results will be displayed in a screen 200. Details of process simulation are, for example, as shown in FIGS. 24, 25 and 26.

FIG. 24 is a basic information entry screen 222 in process simulation, and one enters work items, language, draft, scheduled submission date, desired delivery date, delivery form, index and times of proofreading as basic information. Of these, scheduled submission date and times of proofreading are mandatory items to be entered.

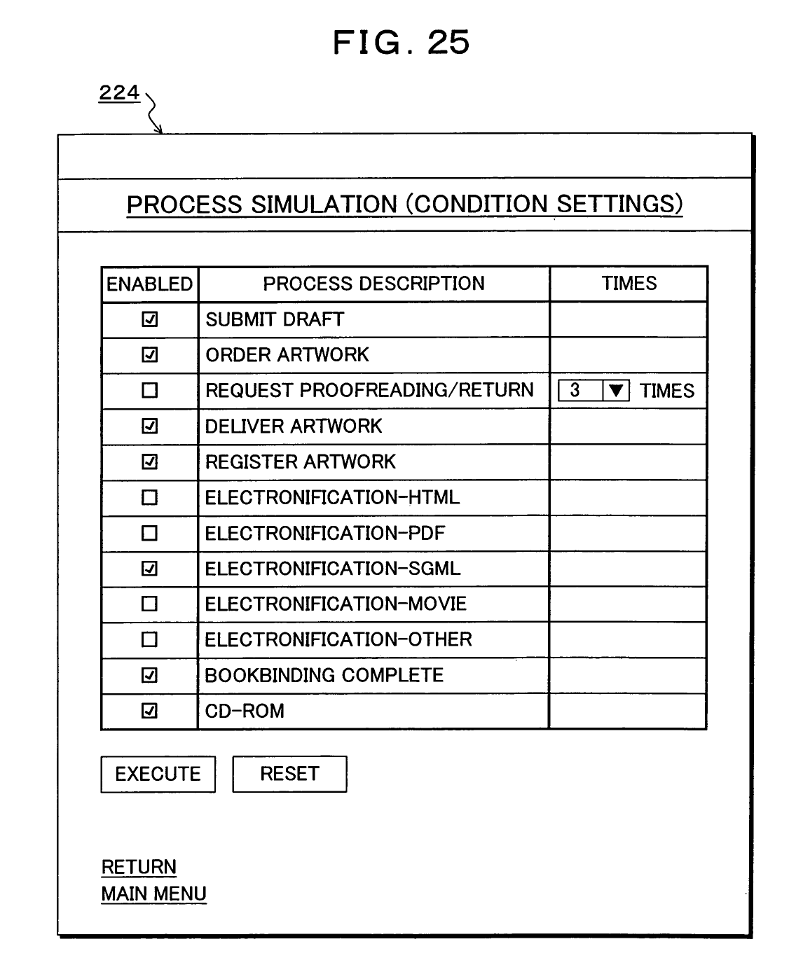

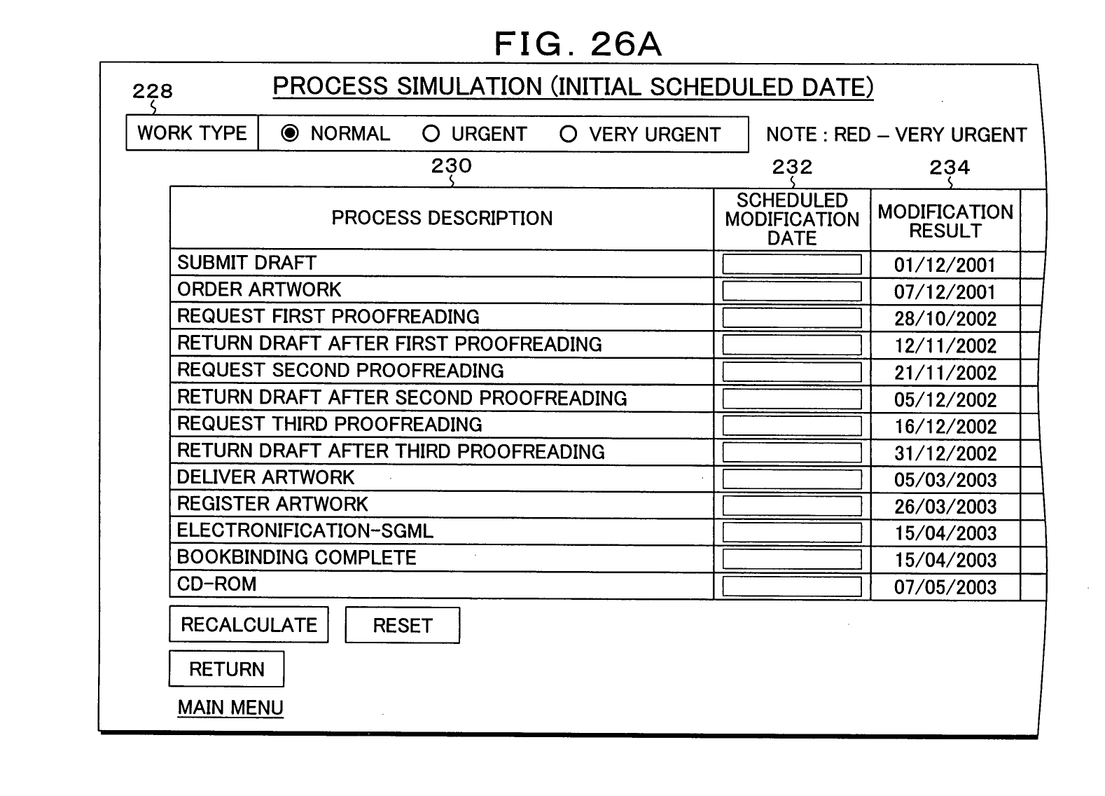

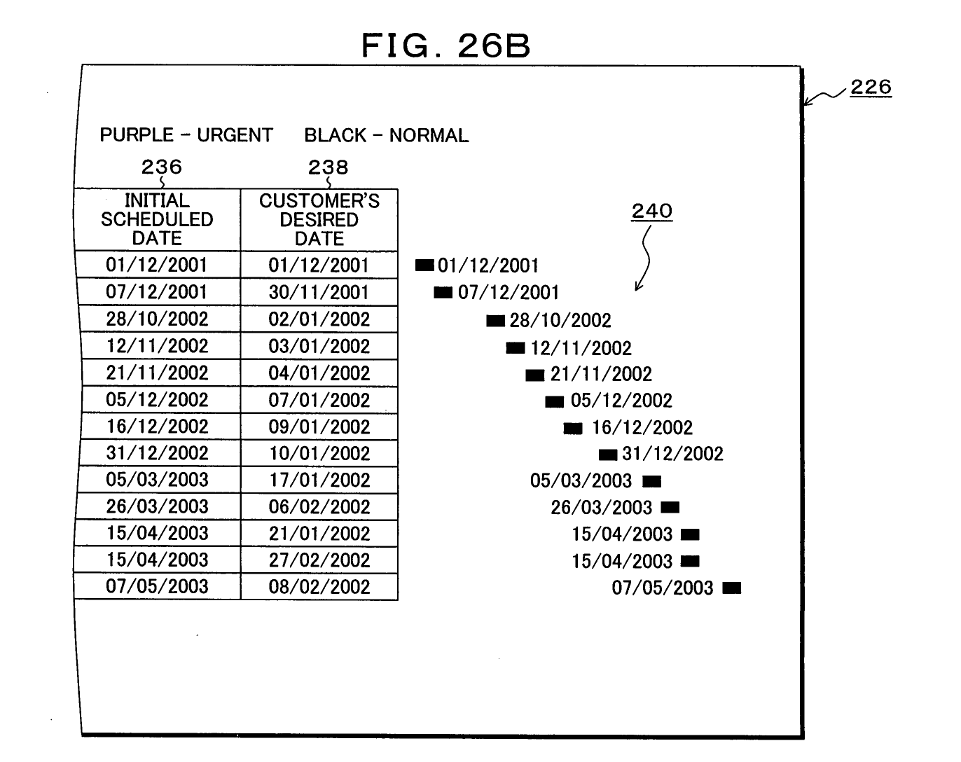

FIG. 25 is a condition setting screen 224 in process simulation, and one enables desired processes by checking them. One also sets the number of times of proofreading/return. Thus, when basic information entry in FIG. 24 and condition settings in FIG. 25 are finished, process simulation is carried out by pressing the Execute button at the bottom of the condition setting screen 224, allowing process simulation results to be displayed as shown in FIG. 26. A process simulation result screen 226 is obtained by “Normal” as default as shown in a work type 228. Date is shown for each of a process description 230, a scheduled modification date 232, a modification result 234, an initial scheduled date 236 and a customer's desired date 238 as process results. Further, a process display 240 rendered visible by a chart graph is provided on the right. In the process results, the initial scheduled date 236, assigned through simulation based on the current progress status of processes on the developing side, is shown for the customer's desired date 238. It is to be noted that the same date is shown for the modification result 234 as for the initial scheduled date 236 as default before modification. As for the modification result, if modification is necessary, one can carry out process simulation again by entering the scheduled modification date 232 and pressing the Recalculate button shown at the bottom, thus displaying a new modified result.

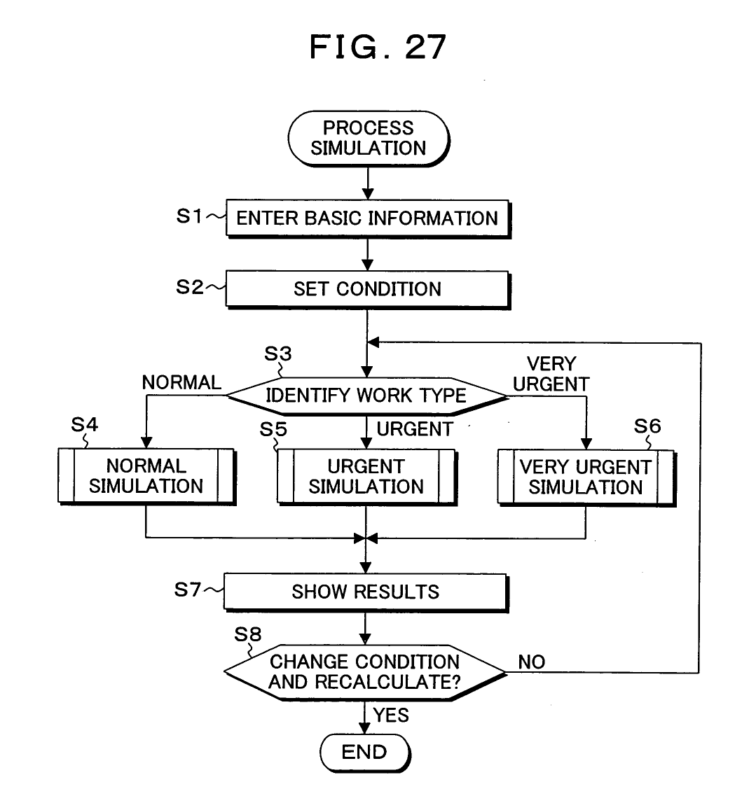

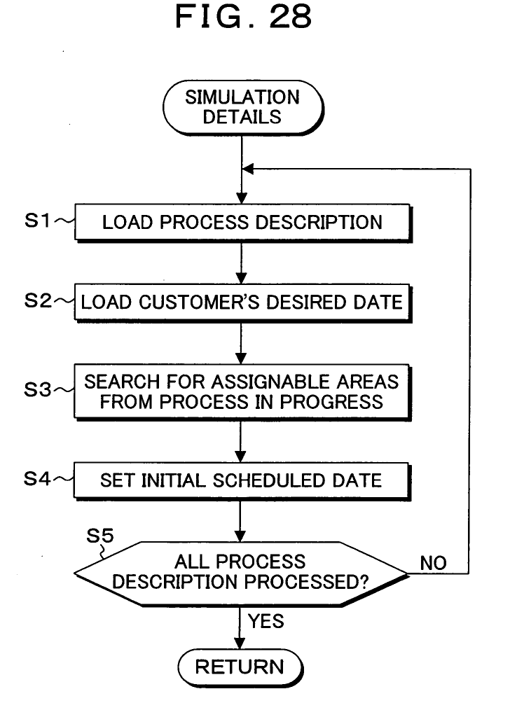

FIG. 27 is a flowchart of process simulation processing steps in the present invention. One enters basic information at Step S1 first, and then sets conditions at Step S2. At Step S3, one identifies work type and carries out process simulation. Since the default work type is “Normal”, normal simulation is performed at Step S4. If “Urgent” or “Very urgent” is selected as work type, simulation of Step S5 or S6 is performed. When simulation is finished, results are displayed at Step S7. If further modifications are necessary to the results, one changes conditions at Step S8 and proceeds with recalculation. This allows the process to repeat from Step S3.

FIG. 28 is simulation details that take “Normal” of Step S4 in FIG. 27 as an example. In the simulation details, individual processes in the process description 230 of FIG. 26 are loaded in succession from top at Step S1. Next, the customer's desired date is loaded at Step S2. Further, assignable areas are searched for from the process in progress at Step S3, and the date found through search is set as the initial scheduled date at Step S4. Next, it is checked at Step S5 whether the description of all processes has been processed. If not, the process returns to Step S1 where the description of the next process is loaded. This procedure is repeated until the description of all processes is processed.

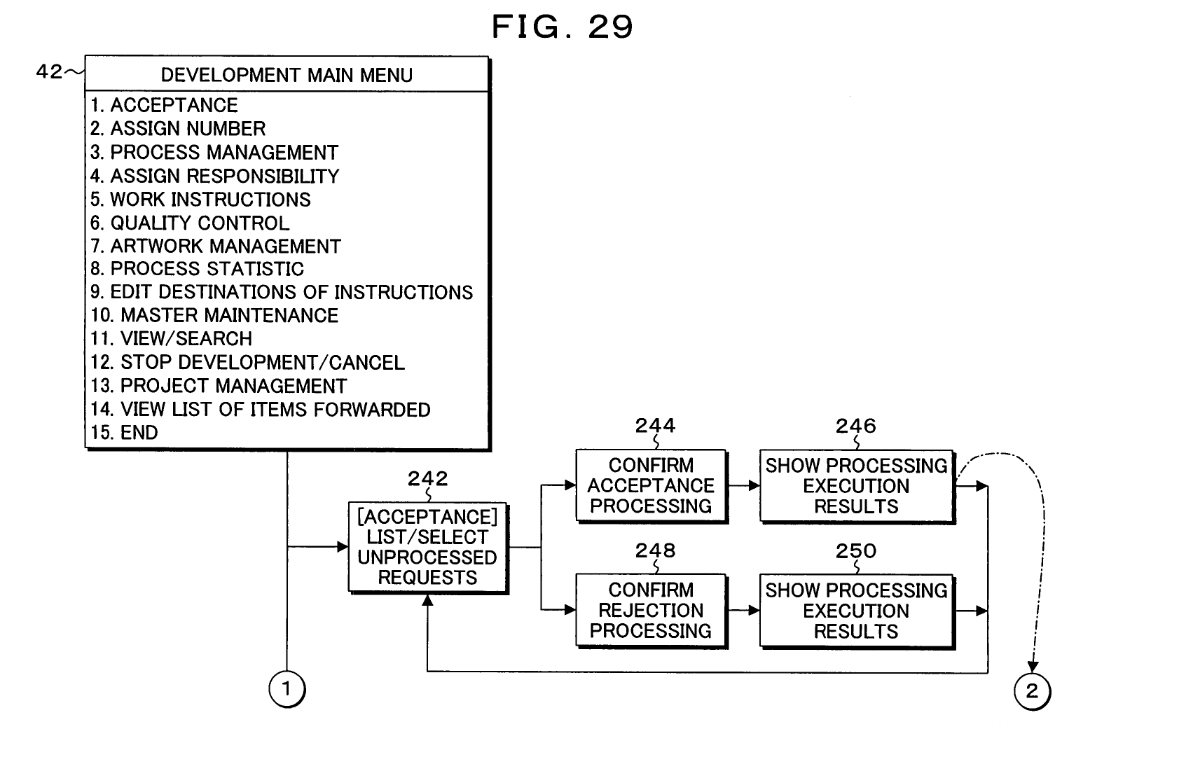

Next, a detailed description will be given with reference to FIGS. 29 to 41 of processings through screen changes using the development main menu 42 in FIG. 4 provided by accessing the manual development support server 10 from the developing-side client 16.

In FIG. 29, when “1. Acceptance”, the first option in the development main menu 42, is selected, a screen 242 opens, allowing listing or selection of unprocessed requests. Here, when listing of unprocessed requests is selected, the screen changes to a screen 244. When acceptance processing is confirmed, execution results of acceptance processing are shown in a screen 246. On the other hand, when selection of unprocessed requests is specified in the screen 242, rejection processing is confirmed in a screen 248. As a result of the confirmation of rejection processing, execution results are shown in a screen 250 for rejecting acceptance.

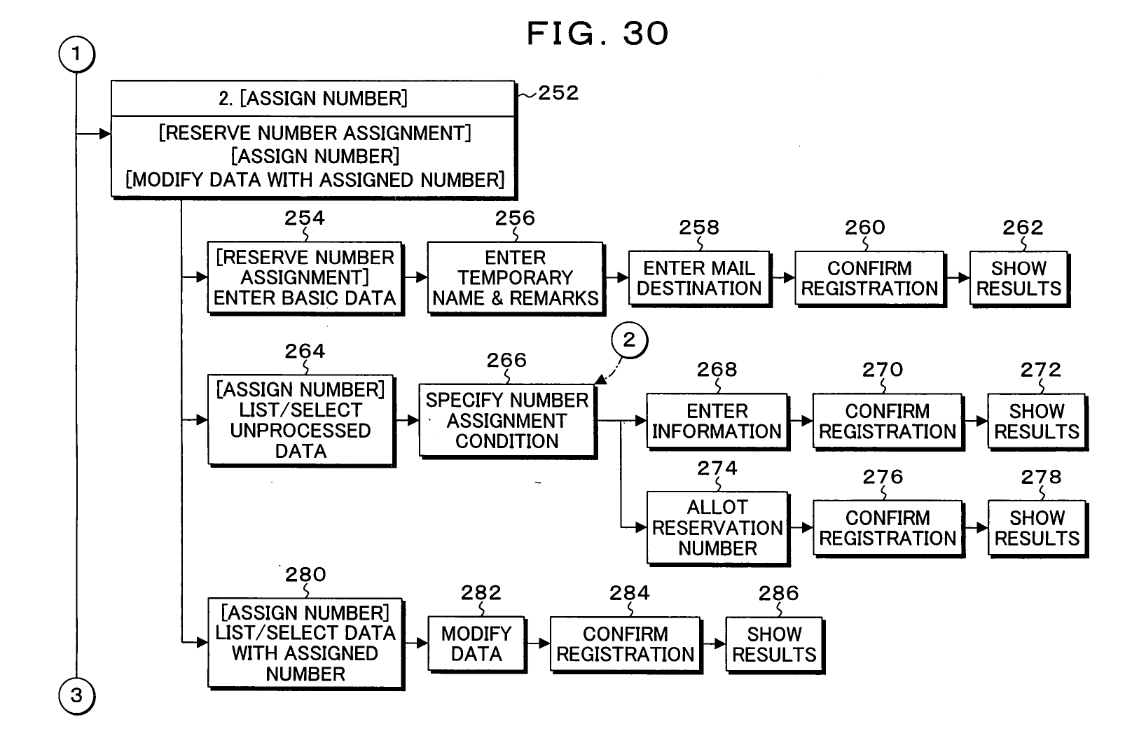

Next, when “2. Assign number” is selected in the development main menu 42 in FIG. 29, the screen changes to a screen 252 in FIG. 30. The screen 252 has three options, namely, [Reserve number assignment], [Assign number] and [Modify data with assigned number] as a submenu. When [Reserve number assignment] is selected in the submenu, the screen changes to a screen 254 where one enters basic data for reservation of number assignment. Next, one enters a temporary name and remarks in a screen 256 and further enters a mail destination in a screen 258. Then, one confirms registration in a screen 260, and results are finally shown in a screen 262. When [Assign number] is selected in the submenu of the screen 252, the screen changes to a screen 264 for listing/selecting unprocessed data. When one specifies a number assignment condition in a next screen 266, one enters information in a screen 268 first and then confirms registration in a screen 270 in the case of listing unprocessed data, as a result of which results are shown in a screen 272. It is to be noted that one can move to the screen 266 for specifying a number assignment condition from the execution result display for acceptance processing in the screen 246. On the other hand, when selection of unprocessed data is selected in the screen 264, the screen changes from the screen 266 to a screen 274 where a reservation number is assigned. Then, one confirms registration in a screen 276, and results are shown in a screen 278. Further, when [Modify data with assigned number] is selected in the submenu of the screen 252, the screen changes to a screen 280 for listing/selecting data with assigned number. Next, when one modifies data in a screen 282, the screen changes to a screen 284 where one confirms registration, and results are finally shown in a screen 286.

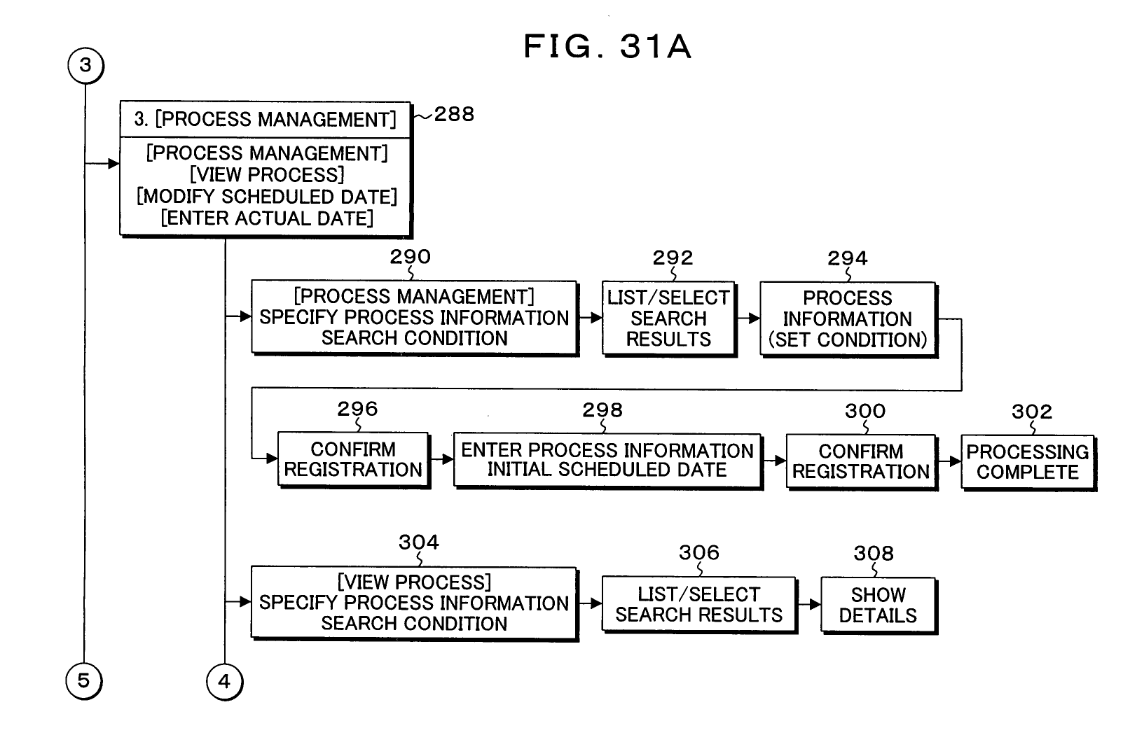

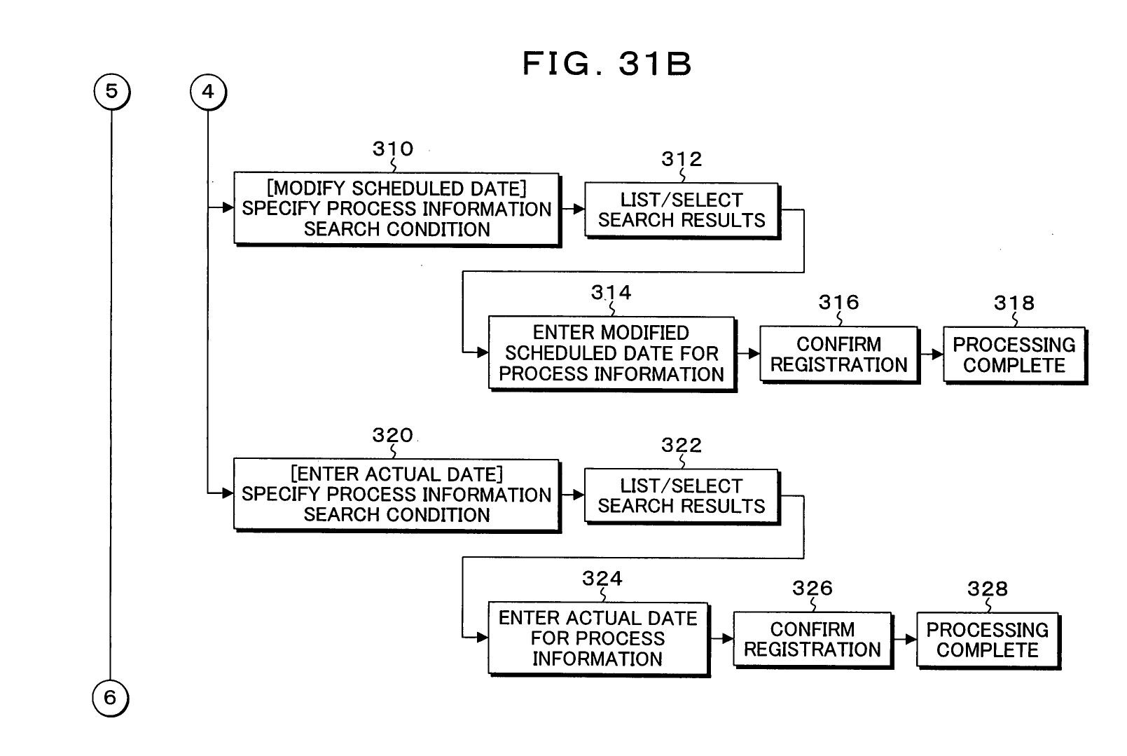

Next, when “3. Process management” is selected in the development main menu 42 in FIG. 29, the screen changes to a screen 288 in FIGS. 31A and 31B. The process management screen 288 shows options, namely, [Process management], [View process], [Modify scheduled date] and [Enter actual date] as a submenu. When [Process management] is selected in the submenu, the screen changes to a screen 290. When one specifies a process information search condition, the screen changes to a screen 292 for listing/selecting search results. Then, when one specifies a condition as process information in a screen 294, the screen changes to a screen 296 where one confirms registration. When one enters a process information initial scheduled date in a screen 298, the processing is complete in a screen 302 after registration confirmation in a screen 300. In the process management using the screens 290 to 302, the initial scheduled date entered in the screen 298 is shown, for example, as the initial scheduled date 236 in the process simulation results shown in FIG. 31. Next, when [View process] is selected in the submenu of the screen 288, one specifies a process information search condition in a screen 304. The screen changes to a screen 306 for listing/selecting search results, and details are shown in a screen 308 as a result of selection from the search result list in the screen 306. When [Modify scheduled date] is selected in the submenu of the screen 288, the screen changes to a screen 310 for specifying a process information search condition. When one specifies this condition, the screen changes to a screen 312 for listing/selecting search results. When one enters a modified scheduled date for process information for the selected search result, the screen changes to a screen 316 for registration confirmation. When one confirms registration, the processing is complete in a screen 318. When a modified scheduled date for process information is entered using the screens 310 to 318, the entered date is entered in the scheduled modification date column shown in FIG. 21. Pressing the Recalculate button allows the modification date to be modified. Further, when [Enter actual date] is selected in the submenu of the screen 288, the screen changes to a screen 320 for specifying a process information search condition. When one lists/selects search results in a screen 322 and then enters a process information actual date in a screen 324, the processing is complete in a screen 328 after registration confirmation in a screen 326.

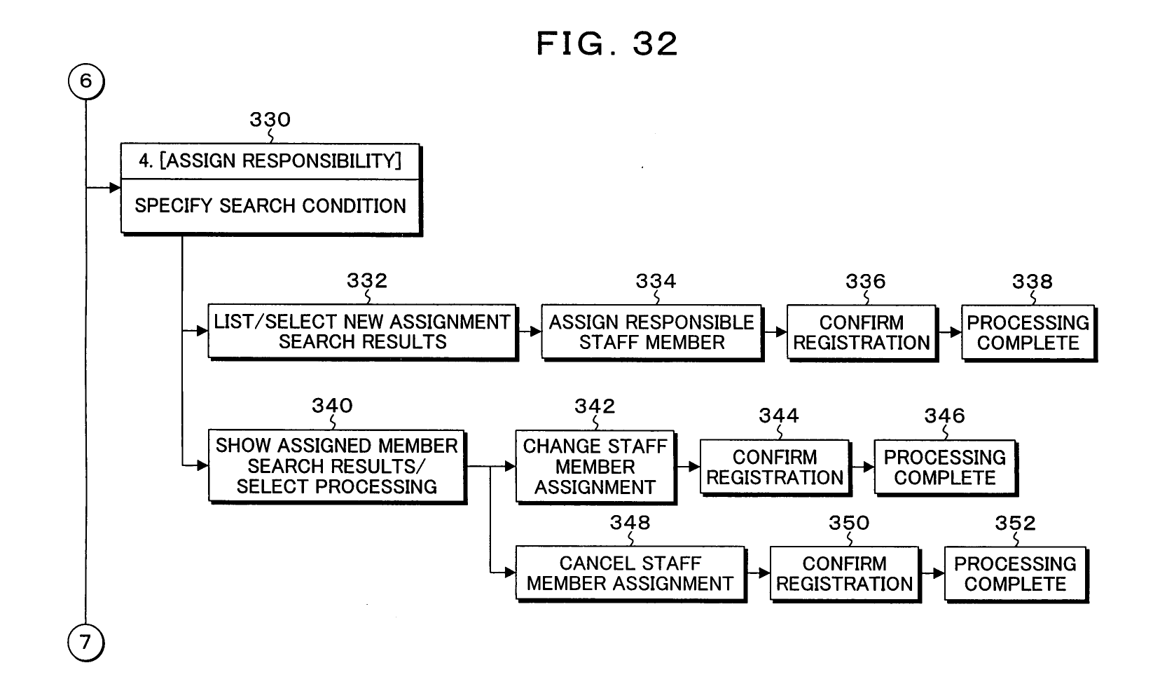

Next, when “4. Assign responsibility”, one of the menu options, is selected in the development main menu 42 in FIG. 29, the screen changes to a screen 330 in FIG. 32 where one specifies a search condition. For search results, one can specify either new assignment search or assigned member search. In the case of new assignment search, the screen changes to a screen 332 for listing/selecting new assignment search results. As a result of the selection, one assigns a responsible staff member in a screen 334. After registration confirmation in a screen 336, the processing is complete in a screen 338. In the case of assigned member search, assigned member search results are shown and processing is selected in a screen 340. In the screen 340, one can change and cancel staff member assignment. When staff member assignment change is selected, one changes staff member assignment in a screen 342, and the processing is complete in a screen 346 after registration confirmation in a screen 344. As for staff member assignment cancellation, on the other hand, one cancels staff member assignment in a screen 348, and the processing is complete in a screen 352 after registration confirmation in a screen 350.

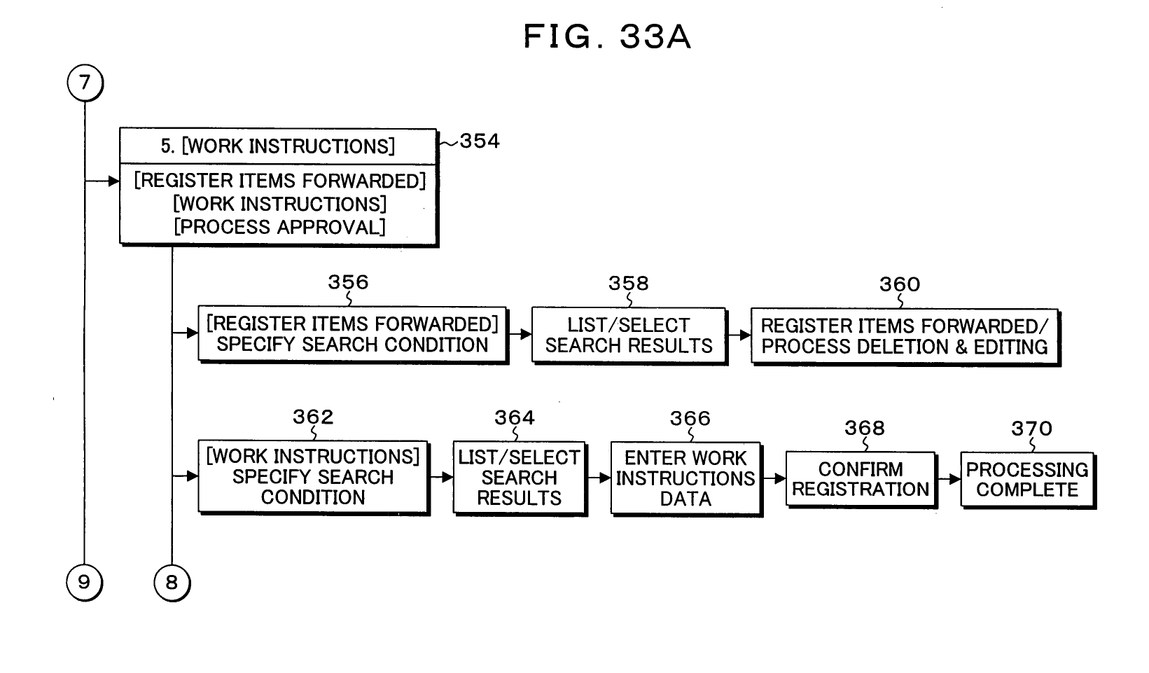

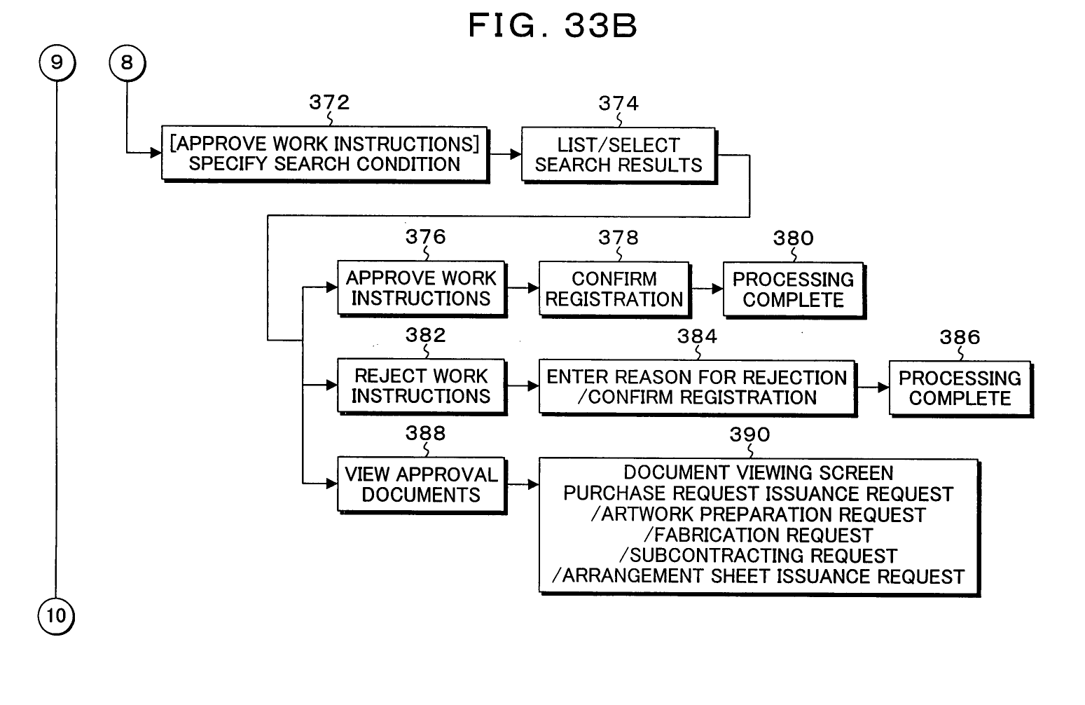

Next, when “5. Work instructions”, one of the menu options, is selected in the development main menu 42 in FIG. 29, the screen changes to a screen 354 in FIGS. 33A and 33B. In the screen 354, [Register items forwarded] [Work instructions] and [Process approval] are selectable as a submenu. When [Register items forwarded] is selected as a submenu option, the screen changes to a screen 356. After specification of a search condition in this screen, search results are listed/selected in a screen 358. Then, one registers or deletes work instructions as an item forwarded or proceeds with editing in a screen 360. When [Work instructions] is selected as a submenu option in the screen 354, the screen changes to a screen 362 where one specifies a work condition. After listing/selection of search results in a screen 364, one enters work instructions data in a screen 366. The processing is complete in a screen 370 after registration confirmation in a screen 368. Further, when [Process approval] is selected as a submenu option in the screen 354, the screen changes to a screen 372. When one specifies a search condition, the screen changes to a screen 374 for listing/selecting search results. In the screen 374, “Approve work instructions”, “Reject work instructions” or “View approval documents” is selected. When “Approve work instructions” is selected, the screen changes to a screen 376. Following approval in this screen, the processing is complete in a screen 380 after registration confirmation in a screen 378. As for “Reject work instructions”, one rejects work instructions in a screen 382. When one enters a document for rejection and confirms registration in a screen 384, the processing is complete in a screen 386. Further, as for “View approval documents”, the screen changes to a screen 388. In a screen 390, a document viewing screen, one can view approval documents related to purchase request issuance request, artwork preparation request, fabrication request, subcontracting request and arrangement sheet issuance request.

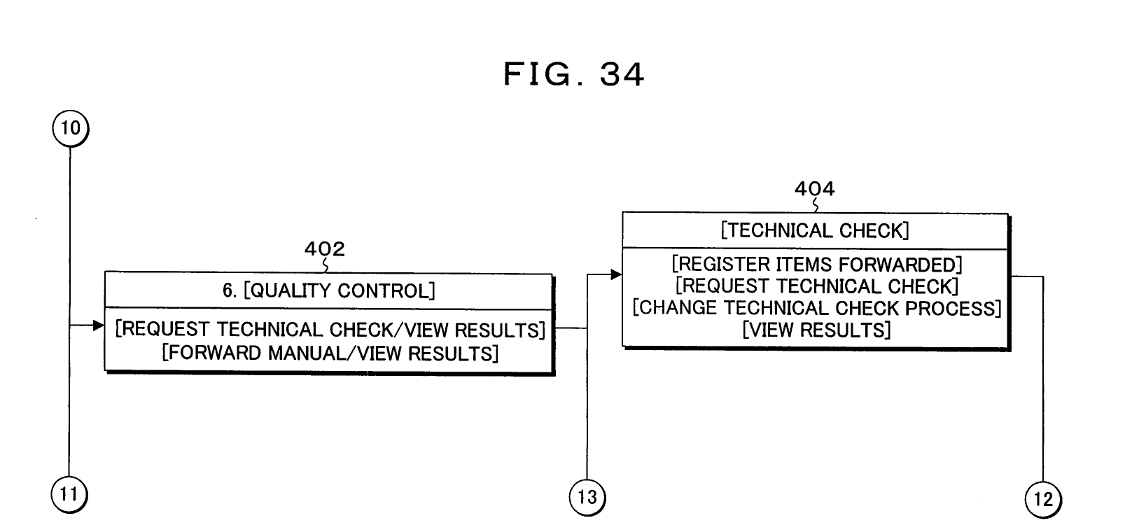

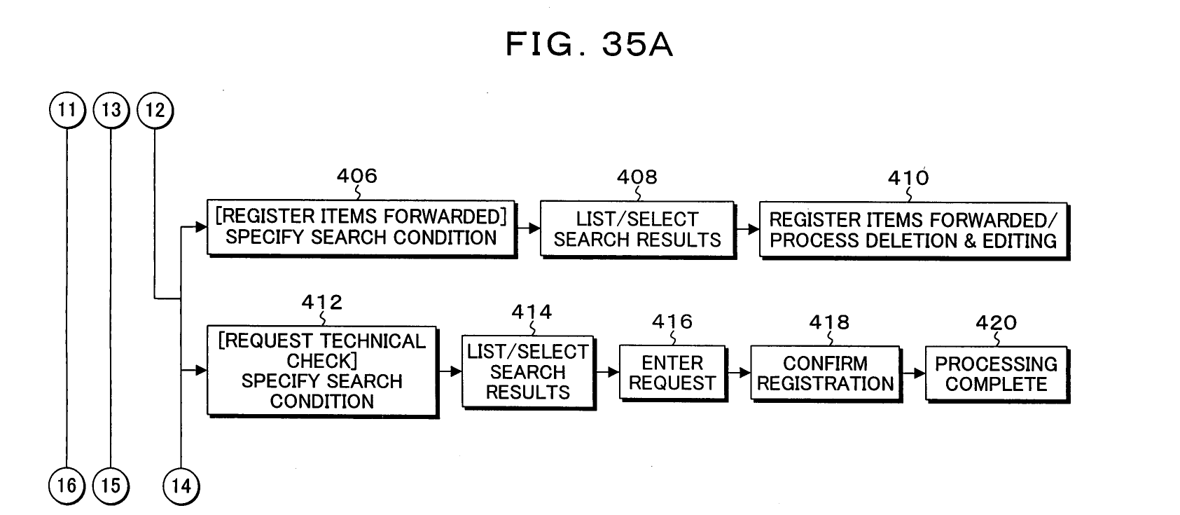

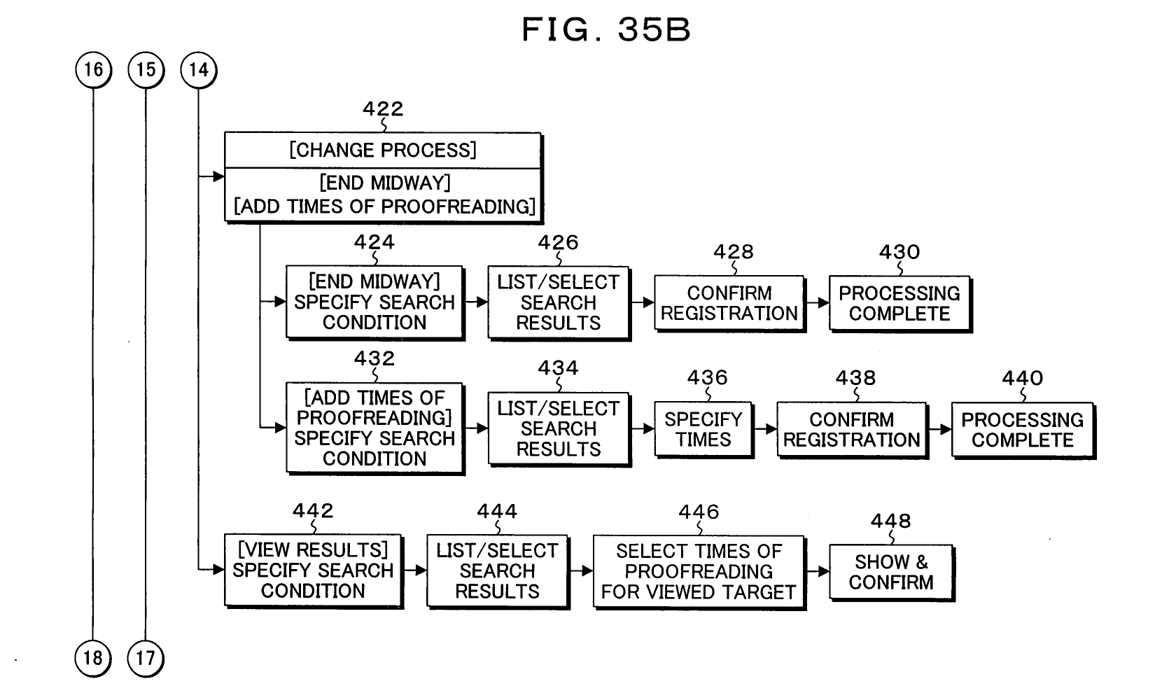

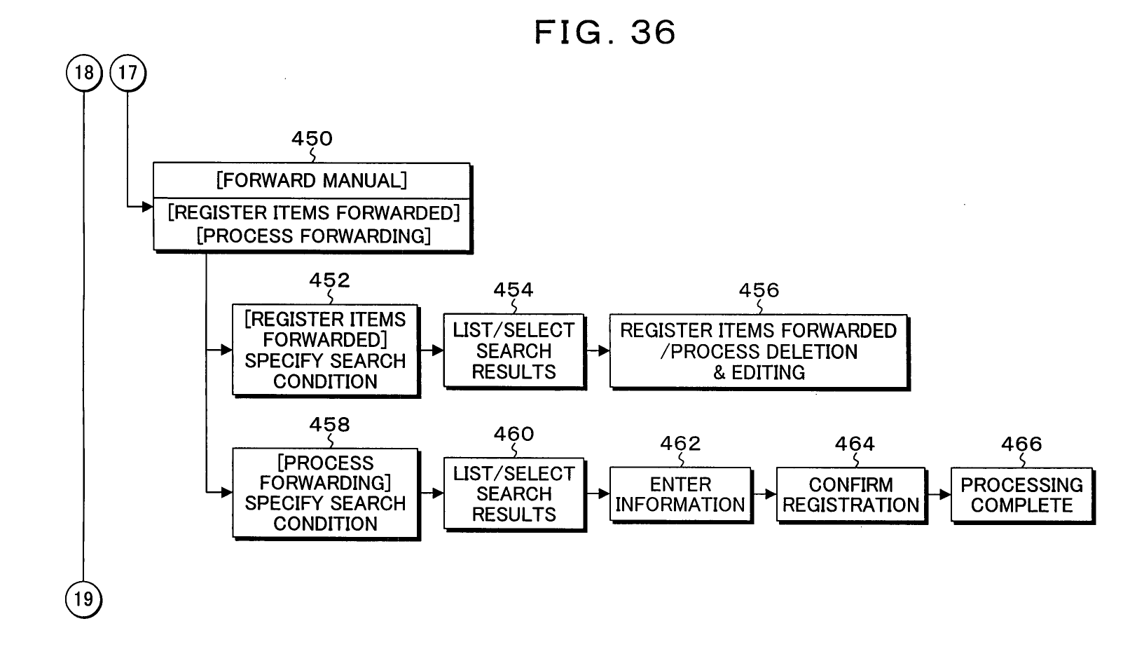

Next, when “6. Quality control” is selected as a menu option in the development main menu 42 in FIG. 29, the screen changes to a screen 402 in FIG. 34. In the screen 402, [Request technical check/view results] and [Forward manual/view results] are available as submenu options. When [Request technical check/view results] is selected in the screen 402, the screen changes to a screen 404 where [Register items forwarded], [Request technical check], [Change technical check process] and [View results] are shown as submenu options related to technical check. In the screen 404, when [Register items forwarded] is selected , the screen changes to a screen 406 in FIGS. 35A and 35B. When one specifies a search condition, the screen changes to a screen 408 for listing/selecting search results. In a screen 410, one can register the item forwarded —the draft whose proofreading is requested—or proceed with editing. When [Request technical check] is selected as a submenu option in the screen 404, the screen changes to a screen 412. After specification of a search condition, the screen changes to a screen 414 for listing/selecting search results. When one enters a request for the selection in a screen 416, the processing is complete in a screen 420 after confirmation registration in a screen 418. When registration is confirmed through entry of the technical check request, artwork draft whose delivery registration for technical check is complete will be automatically transmitted to the developing side with an email. When [Change technical check process] is selected as a submenu option in the screen 404, the screen changes to a screen 422 where [End midway] and [Add times of proofreading] are shown as submenu options. When [End midway] is selected as a submenu option, the screen changes to a screen 424. After specification of a search condition, the screen changes to a screen 426 for listing/selecting search results. When one selects a target to be ended midway, the processing is finally complete in a screen 430 after registration confirmation in a screen 438. When [Add times of proofreading] is selected as a submenu option in the screen 422, the screen changes to a screen 432. After specification of a search condition, the screen changes to a screen 434 for listing/selecting search results. Following selection of a specific target and specification of number of times in a screen 436, the processing is complete in a screen 440 after registration confirmation in a screen 438. Further, when [View results] is selected as a submenu option in the screen 404, the screen changes to a screen 442 where one specifies a search condition. Then, the screen changes to a screen 444 for listing/selecting search results. When, as a result of the selection, one selects the number of times of proofreading—a target to be viewed—from among a plurality of preset numbers of times in a screen 446, one can confirm display of technical check results for the selected number of times in a screen 448. When [Forward manual/view results] is selected as a submenu option in the screen 402, the screen changes to a screen 450 in FIG. 36. In the screen 450, [Register items forwarded] and [Process forwarding] are selectable as submenu options. When [Register items forwarded] is selected as a submenu option, the screen changes to a screen 452 where one specifies a search condition. The screen changes to a screen 454 for listing/selecting search results. Then, one registers or deletes an item forwarded or proceeds with editing in a screen 456. When [Process forwarding] is selected in the screen 450 as a submenu option, the screen changes to a screen 458 where one specifies a search condition. The screen changes to a screen 460 for listing/selecting search results. Then, one enters information necessary for forwarding processing for the selected target in a screen 462, and the processing is complete in a screen 466 after registration confirmation in a screen 464.

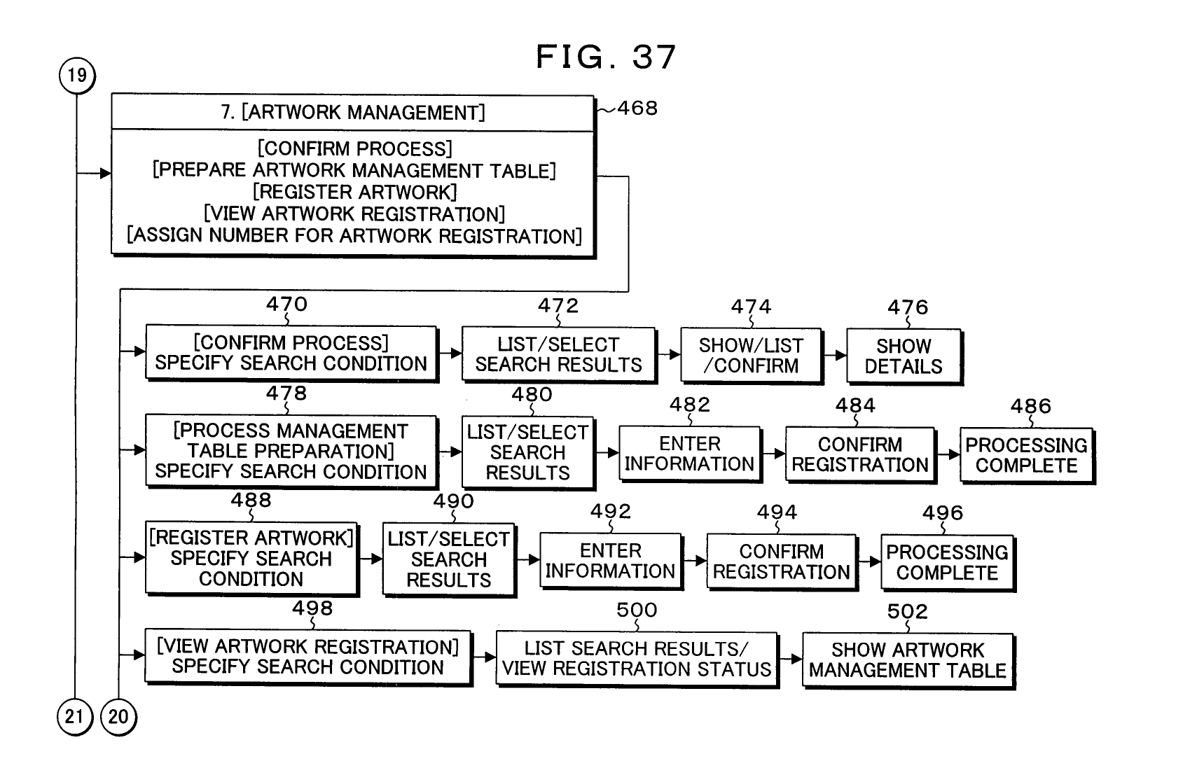

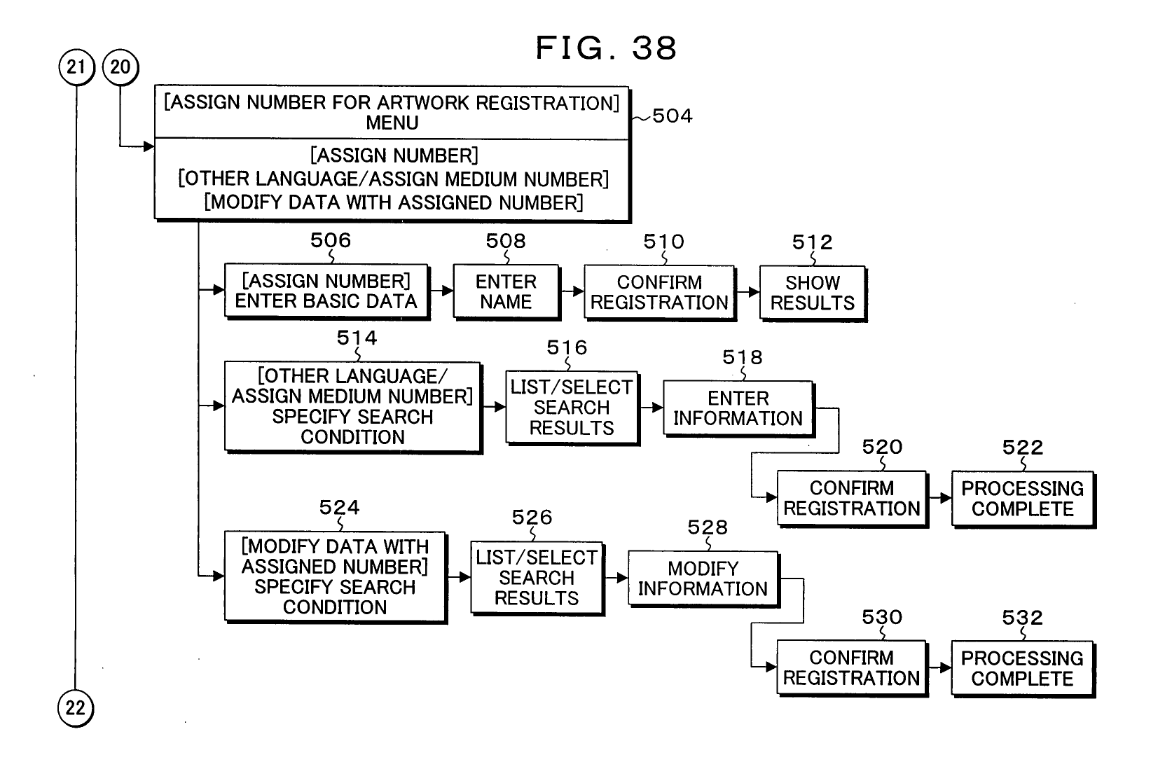

Next, when “7. Artwork management”, one of the menu options, is selected in the development main menu 42 in FIG. 29, the screen changes to a screen 468 in FIG. 37. In the screen 468, [Confirm process], [Prepare artwork management table] , [Register artwork] [View artwork registration] and [Assign number for artwork registration] are selectable as submenu options. When [Confirm process], one of the submenu options, is selected, the screen changes to a screen 470 where one specifies a search condition. The screen changes to a screen 472 for listing/selecting search results. After a list is shown and confirmation made for the selected target in a screen 474, details are shown in a screen 476. When [Prepare artwork management table], one of the submenu options, is selected in the screen 468, the screen changes to a screen 478. After specification of a search condition in the screen 478, the screen changes to a screen 480 for listing/selecting search results. Following entry of information necessary for preparation of artwork management table for the selected target in a screen 482, the processing is complete in a screen 486 after registration confirmation in a screen 484. When [Register artwork], one of the submenu options, is selected in the screen 468, the screen changes to a screen 488. After specification of a search condition, the screen changes to a screen 490 for listing/selecting search results. Following entry of information necessary for artwork registration for the selected target in a screen 492, the processing is complete in a screen 496 after registration confirmation in a screen 494. When [View artwork registration], one of the submenu options, is selected n the screen 468, the screen changes to a screen 498. After specification of a search condition, the screen changes to a screen 500 for listing search results/viewing registration status. When one selects a target from the list, artwork management table can be displayed in a screen 502. Further, when [Assign number for artwork registration] one of the submenu options, is selected in the screen 468, the screen changes to a screen 504 in FIG. 38. In the screen 504, [Assign number], [Other language/assign medium number] and [Modify data with assigned number] are selectable as submenu options. When [Assign number] is selected as a menu option, the screen changes to a screen 506 where one enters basic information necessary for number assignment. Then, one enters a name in a screen 508. As a result, one confirms registration in a screen 510, and then results are shown in a screen 512. When [Other language/assign medium number] , a menu option, is selected in the screen 504, the screen changes first to a screen 514 for specifying a search condition and then to a screen 516 for listing/selecting search results. Following entry of information necessary for number assignment in a screen 518, the processing is complete in a screen 522 after registration confirmation in a screen 520. Further, when [Modify data with assigned number] is selected in the screen 504, the screen changes first to a screen 524 for specifying a search condition and then to a screen 526 for listing/selecting search results. Following modification of information in a screen 528, the processing is complete in a screen 532 after registration confirmation in a screen 530.

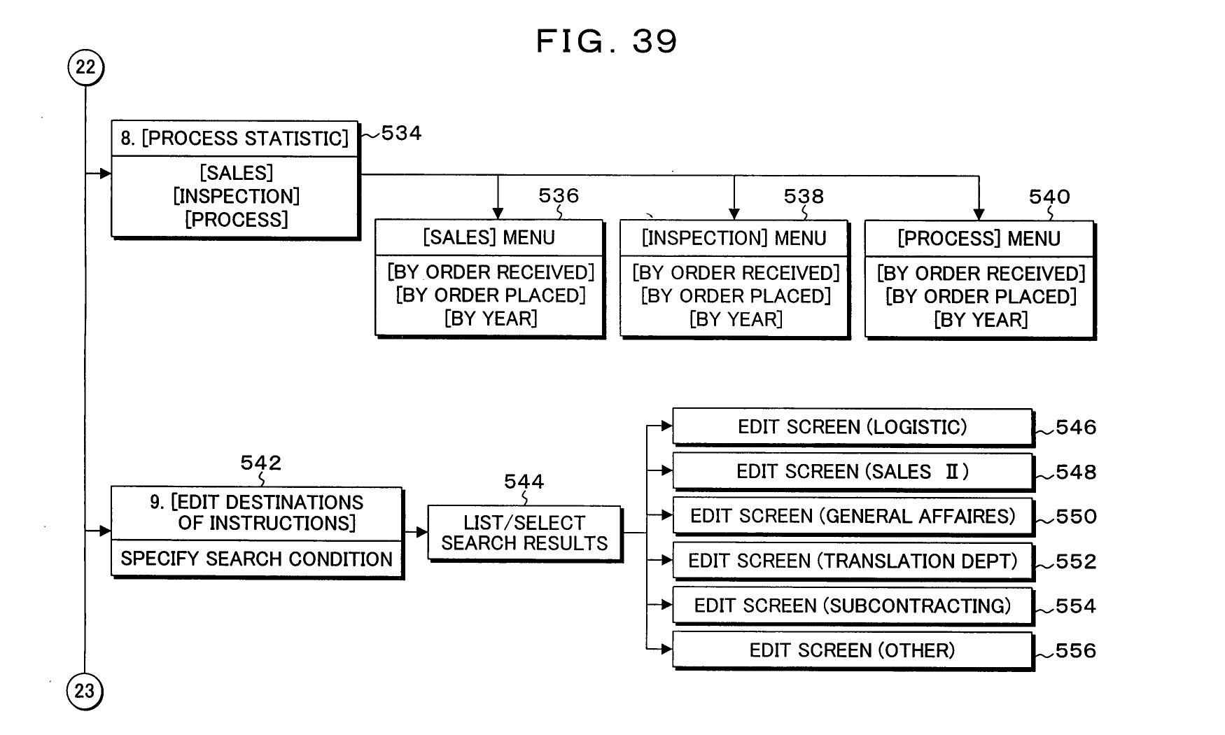

Next, when “8. Statistic processing”, one of the menu options, is selected in the development main menu 42 in FIG. 29, the screen changes to a screen 534 in FIG. 39. In the screen 534, [Sales], [Inspection] and [Process] are available as submenu options. When these options are selected, the screen changes to the sales menu in a screen 536, the inspection menu in a screen 538 and the process menu in a screen 540 where statistical results are obtained respectively by order received, order placed and year.

Next, when “9. Edit destinations of instructions”, one of the menu options, is selected in the development main menu 42 in FIG. 29, the screen changes to a screen 542 in FIG. 39. After specification of a search condition, the screen changes to a screen 544 for listing/selecting search results and then to one of screen 546 to 556 for the selection made. The screens 546 to 556 are each edit screens shown for each destination of instructions such as logistic, sales II, general affaires, translation, subcontracting and other, allowing necessary editing of the destination.

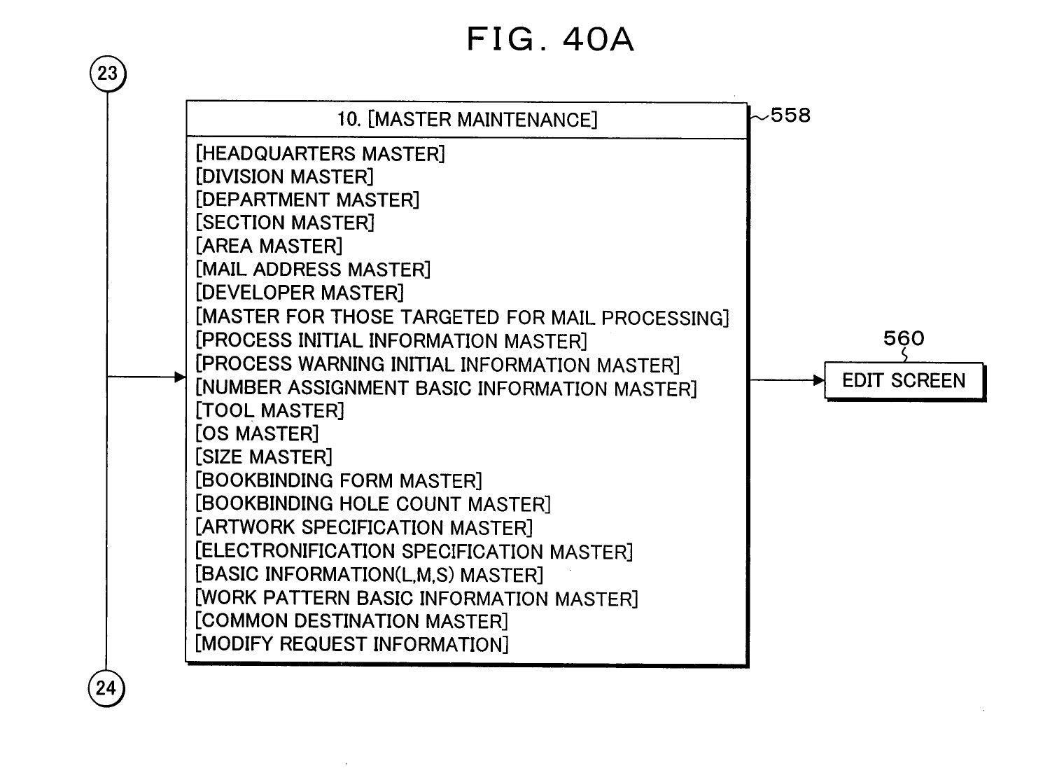

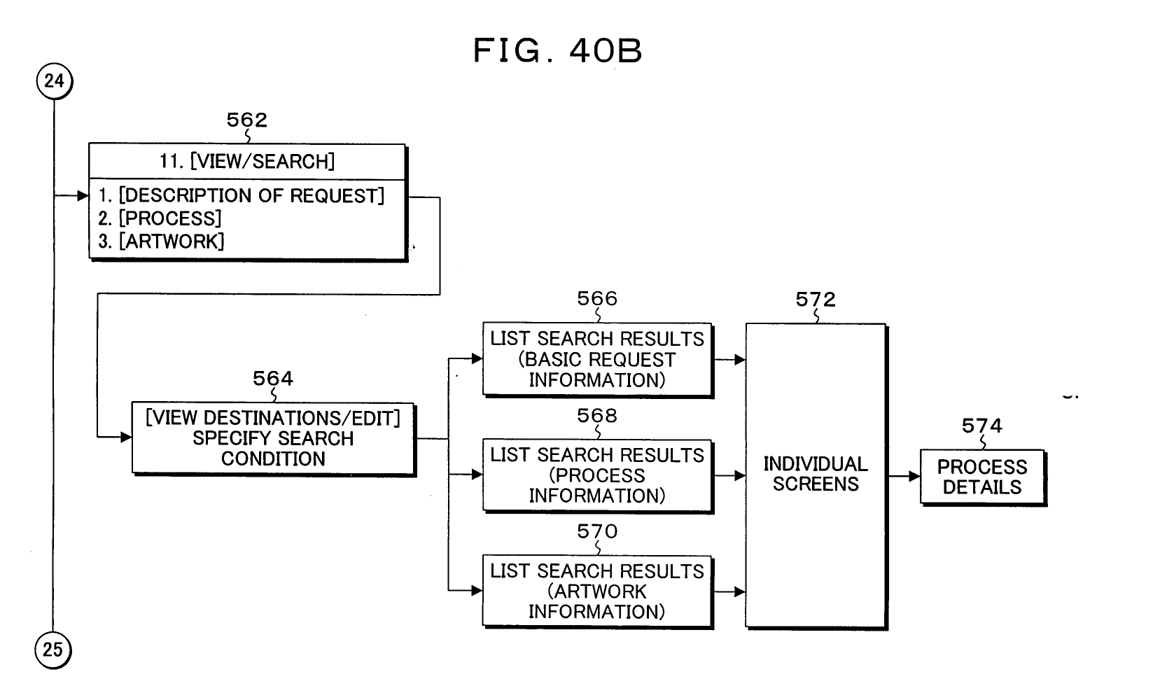

Next, when “10. Master maintenance” is selected in the development main menu 42 in FIG. 29, the screen changes to a screen 558 in FIGS. 40A and 40B. In the screen 558, master options—maintenance targets—are listed. When any of the options is selected, editing necessary for maintenance is possible with an edit screen 560.

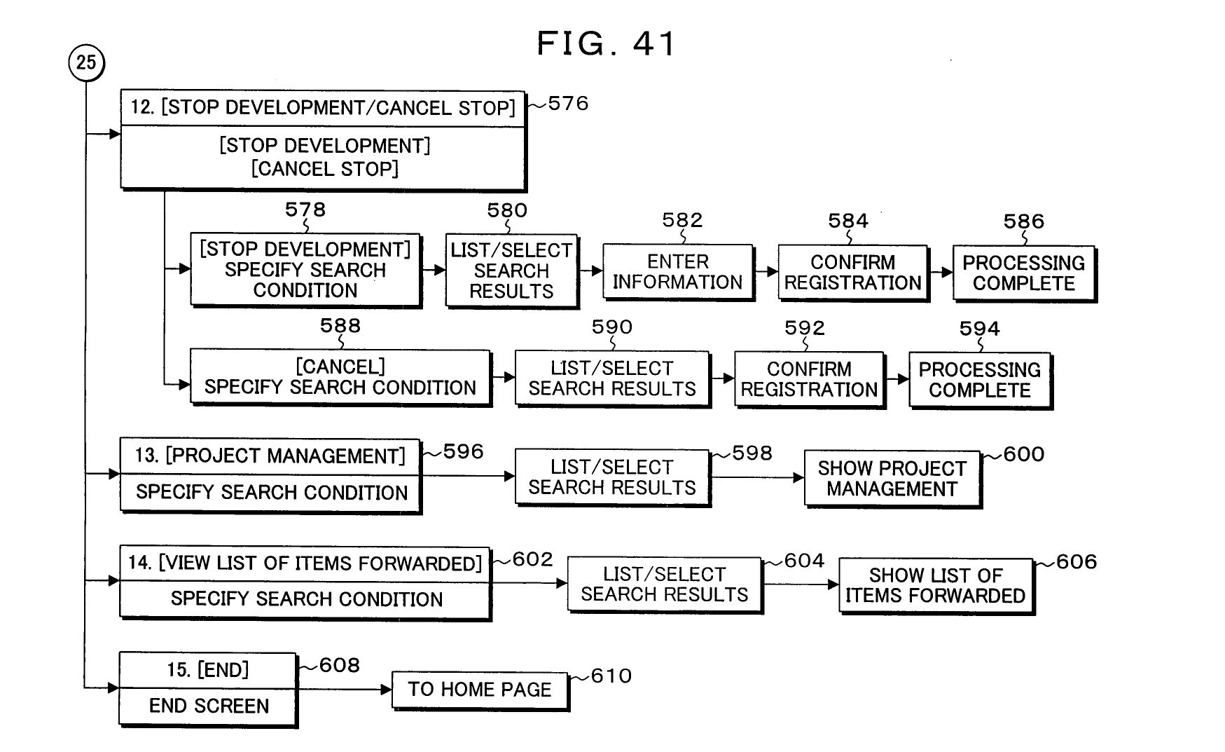

Next, when “11. View/search” is selected in the development main menu 42 in FIG. 29, the screen changes to a screen 562 in FIG. 41. In the screen 562, [Description of request], [Process] and [Artwork] are available as submenu options. When any one of the submenu options is selected in the screen 562, the screen changes to a screen 564 where one enters a search condition. In response to the entry of search condition, basic request information is shown as search result list in a screen 566 in the case of [Description of request]. As for [Process], process information is shown in a screen 568 as search result list. Further, as for [Artwork], artwork information is shown in a screen 570 as search result list. If specific information is selected in the screen 566, 568 or 570, the screen changes to an individual search screen 572. In the search screen, one selects a specific option, thus allowing process information to be shown in a screen 574.

Next, when “12. Stop development/cancel” is selected in the development main menu 42 in FIG. 29, the screen changes to a screen 576 in FIG. 41. In the screen 576, [Stop development] and [Cancel stop] are selectable as submenu options. When [Stop development] is selected, the screen changes first to a screen 578 for specifying a search condition and then to a screen 580 for listing/selecting search results. Following entry of information for stopping development in a screen 582, the processing is complete in a screen 586 after registration confirmation in a screen 584. When [Cancel stop] is selected, the screen changes first to a screen 588 for specifying a search condition and then to a screen 590 for listing/selecting search results. The processing is complete in a screen 594 after registration confirmation for selected cancellation of the stop in a screen 592.

Next, when “13. Project management”, one of the menu options, is selected in the development main menu 42 in FIG. 29, the screen changes to a screen 596 in FIG. 41. When a search condition is specified in this screen, the screen changes to a screen 598 for listing/selecting search results. After selection, the screen changes to a screen 600 where project management is shown.

Further, when “14. View list of items forwarded”, one of the menu options, is selected in the development main menu 42 in FIG. 29, the screen changes to a screen 602 in FIG. 41. When a search condition is specified in the screen 602, the screen changes to a screen 604 for listing/selecting search results. A list of items forwarded is shown in a screen 606 for the selected target.

Further, when “15. End”, one of the menu options, is selected in the development main menu 42 in FIG. 29, the screen changes to an end screen 608 in FIG. 41. After end operation, the screen changes to a home page in a screen 610.

Here, while a series of processings from menu selection are shown as individual screen processings in FIGS. 29 to 41, this is merely for the sake of convenience in explanation. In actuality, it is possible to display entry fields and control buttons in a specific menu screen upon opening of the screen, thus allowing entry of necessary information, confirmation and display of results in a multi-screen display.

Next, a description will be given of a recording medium storing the manual preparation processing programs of the present invention. The manual preparation processing programs of the present invention are programs that serve the functions of the requesting-side application provision unit 28 and the developing-side application provision unit 30 of the application server 24 provided in the manual development support server 10 shown in FIG. 2. More specifically, these programs are the program in the flowchart of FIG. 7 for requesting-side processings and the program in the manual development processing flowchart shown in FIGS. 8 and 9 for developing-side processings. Among computer-readable recording mediums storing such requesting-side and developing-side processing programs are a portable recording medium such as CD-ROM, floppy disk (R), DVD disk, magneto-optical disk and IC card, a storage device such as hard disk provided inside or outside computer, a database holding programs via a circuit, other computer system and its database and a transmission medium on circuit. The requesting-side and developing-side processing programs of the present invention stored in such a computer-readable recording medium are run after installation in a computer making up the manual development support server 10 shown in FIG. 2.

It is to be noted that the present invention is not limited to the aforementioned embodiment and includes appropriate modifications which do not suppress the object or advantage thereof. Further, the present invention is not subject to limitations by the values shown in the above embodiment.

Industrial Applicability

As described above, it is possible according to the present invention to properly and easily prepare a development plan in advance on the requesting side—where hardware development is underway—for the optimal development processes from manual artwork preparation to bookbinding and electronification through process simulation.

Exchanges of instructions and information between the requesting side and the developing side are electronically conducted through a Web page provided by a manual development support server, thus making it possible to perform all tasks on the developing-side client, namely, requesting preparation, forwarding a draft, returning the proofread draft after proofreading request and performing acceptance check on delivered manual after artwork completion. It is possible also for the developing side to perform all tasks electronically on the developing-side client, namely, handling acceptance, assigning number, coordinating processes, assigning responsible staff member, receiving draft, preparing instructions, performing technical check in which proofreading is requested and proofread draft is returned, delivering manual, registering artwork and handling bookbinding and electronification. In particular, exchanges of artwork draft—exchanges in which request for proofreading of artwork draft and return of proofread draft are repeated—can be conducted electronically in artwork development, ensuring speedy and easy proofreading request and proofreading check. This in turn considerably enhances work efficiency in artwork development. Besides, draft modifications are conducted properly both on the developing and requesting sides, ensuring efficiency in artwork development.

Moreover, manual models are available as tools for the requesting side, allowing speedy preparation of draft by the developing side through use of models in manual draft preparation.

Similarly, critical reading/proofreading tool is provided for artwork draft proofreading, allowing efficient electronic critical reading or proofreading on the developing-side client using the critical reading/proofreading tool in response to technical check request to the developing side. In particular, freehand modification on web draft with a red pen using the tool facilitates proofreading by critical reading and proofreading-related discussions on the developing side.

1. A manual preparation support method comprising:
a process simulation step of supporting manual artwork development planning for manual artwork development through simulation of processes from manual preparation request to delivery based on information entered by the requesting side,
a preparation request step of transmitting a manual preparation request prepared by the requesting side to the developing side;
a process management step of accepting the preparation request, acquiring an assigned number, and providing the progress status of processes from draft forwarding to artwork development and bookbinding in a visible manner on the developing side;
an artwork development step of preparing artwork by way of receipt of draft from the requesting side, and editing, proofreading and technical check on the developing and requesting sides; and
a bookbinding/distribution step of delivering a manual by handling bookbinding and/or recording to an electronified medium.

2. The manual preparation support method according to claim 1, wherein the process simulation step includes setting work items, language, number of pages of draft, scheduled submission date, desired date, and number of times of proofreading as basic information for specifying data format on web, and wherein the process simulation step includes displaying and outputting individual processes of draft submission, artwork ordering, draft request, return of proofread draft, another request for proofreading, another return of proofread draft, artwork delivery, artwork registration, artwork electronification, completion of bookbinding, and completion of CD-ROM through simulation based on the basic information.

3. The manual preparation support method according to claim 1, wherein the preparation request step includes:
a request type specification step of specifying new request, new reuse request, reuse request in other language or revision request; and
an entry step of entering given basic information, requesting source information and destinations of distribution related to preparation request.

4. The manual preparation support method according to claim 3, wherein the new request step includes entering work items, language, number of pages of draft, scheduled submission date, desired date, and number of times of proofreading as the basic information for specifying data format on web and entering whether or not approval is necessary, date of request, requester, approver, product number, document number, and destination of technical inquiry as the requesting source information.

5. The manual preparation support method according to claim 1, wherein the process management step includes rendering processes visible by separating the processes into draft submission, artwork ordering, draft request, return of proofread draft, another request for proofreading, another return of proofread draft, artwork delivery, artwork registration, artwork electronification, completion of bookbinding, and completion of CD-ROM.

6. The manual preparation support method according to claim 5, wherein the process management step includes managing the processes by entering an initial scheduled date, a customer's desired date, a scheduled modification date, and an actual modification date for each of the processes, and wherein the processes are rendered visible depending on specification of the initial scheduled date, the customer's desired date, the scheduled modification date, and the actual modification date.

7. The manual preparation support method according to claim 1, wherein the artwork development step includes:
a forwarded item registration step of specifying an artwork draft for first proofreading or artwork draft returned after proofreading and registering the artwork draft as item forwarded on the requesting side; and
a draft forwarding step of automatically transmitting the registered artwork draft to the developing side.

8. The manual preparation support method according to claim 1, wherein the artwork development step includes:
a forwarded item registration step of specifying an artwork draft to be worked on and registering the artwork draft as item forwarded;
a work instruction entry step of entering work instructions related to the registered item forwarded such as proofreading request; and
an approval processing step of approving entered work instructions and automatically transmitting the work instructions to the requesting source.

9. The manual preparation support method according to claim 1, wherein the artwork development step includes on the developing side,
a forwarded item registration step of specifying an artwork draft to be technical checked and registering the artwork draft as item forwarded; and
a technical check request step of automatically transmitting to the requesting source a technical check for given check items related to the registered artwork draft, and wherein the artwork development step includes on the requesting source,
a forwarded item registration step of specifying an artwork draft whose technical check is requested and registering the artwork draft as item forwarded; and
a technical check notification step of transmitting to the developing side check results in response to technical check request for the registered artwork draft.

10. The manual preparation support method according to claim 1, wherein the artwork development step includes on the developing side,
a forwarded item registration step of specifying an artwork draft to be delivered and registering the artwork draft as item forwarded; and
a delivery check request step of transmitting to the requesting source a delivery check for given check items related to the registered artwork draft, and wherein the artwork development step includes on the requesting source,
a forwarded item registration step of specifying an artwork draft whose delivery check is requested and registering the artwork draft as item forwarded; and
a delivery check notification step of notifying acceptance or redelivery to the developing side as a delivery check result for the registered artwork draft.

11. The manual preparation support method according to claim 1, wherein each of the steps is executed on a server in response to access from either a requesting-source client or a developing client connected via a network and notified to the other client.

12. A Program operable to cause a computer to execute:
a process simulation step of supporting manual artwork development planning for manual artwork development through simulation of processes from manual preparation request to delivery based on information entered by the requesting side;
a preparation request step of transmitting a manual preparation request prepared by the requesting side to the developing side;
a process management step of accepting the preparation request, acquiring an assigned number, and providing the progress status of processes from draft forwarding to artwork development and bookbinding in a visible manner on the developing side;
an artwork development step of preparing artwork by way of receipt of draft from the requesting side, and editing, proofreading and technical check on the developing and requesting sides; and
a bookbinding/distribution step of delivering a manual by handling bookbinding and/or recording to an electronified medium.

13. A computer-readable recording medium having therein stored a program operable to cause a computer to execute:
a process simulation step of supporting manual artwork development planning for manual artwork development through simulation of processes from manual preparation request to delivery based on information entered by the requesting side;
a preparation request step of transmitting a manual preparation request prepared by the requesting side to the developing side;
a process management step of accepting the preparation request, acquiring an assigned number, and providing the progress status of processes from draft forwarding to artwork development and bookbinding in a visible manner on the developing side;
an artwork development step of preparing artwork by way of receipt of draft from the requesting side, and editing, proofreading and technical check on the developing and requesting sides; and
a bookbinding/distribution step of delivering a manual by handling bookbinding and/or recording to an electronified medium.
